(19) United States
(12) Patent Application Publication
(10) Pub. No.: US 2020/0327426 A1
(43) Pub. Date: Oct. 15, 2020

(54) ENABLING SEMANTICS REASONING SERVICE IN M2M/IOT SERVICE LAYER

(71) Applicant: CONVIDA WIRELESS, LLC

(72) Inventors: Hongkun LI, Malvern, PA (US); Xu LI, Plainsboro, NJ (US); Chonggang WANG, Princeton, NJ (US); Catalina Mihaela MLADIN, Hatboro, PA (US); Qing LI, Princeton Junction, NJ (US); Rocco DI GIROLAMO, Laval (CA); Michael F. STARSINIC, Newtown, PA (US); Gregory S. STERNBERG, Mt. Laurel, NJ (US)

(21) Appl. No.: 16/305,565

(22) PCT Filed: Jun. 2, 2017
(86) PCT No.: PCT/US2017/035701

§ 371 Date: Nov. 29, 2018

Related U.S. Application Data
(60) Provisional application No. 62/344,700, filed on Jun. 2, 2016.

(51) Int. Cl. G06N 5/02; G06F 40/30; G06F 16/36

(52) U.S. Cl. CPC G06N 5/025; G06F 16/367; G06F 40/30; G06N 5/022

(57) ABSTRACT

Enabling semantic reasoning service within the semantic framework in a M2M/IoT system includes: 1) an overall in architecture of semantic reasoning processor, which highlights the functional components and flows of the reasoning process; 2) defined procedures for reasoning rule management in M2M/IoT systems (e.g., create and delete) for different scenarios; 3) procedures for triggering and performing the semantic reasoning process in M2M/IoT systems, which may be triggered by semantic query and semantic annotation process in on-demand and proactive manner; and 4) methods of dealing with and processing the new information generated through semantic reasoning process, which may include generating more semantic information to describe the information generated (e.g., new data content).

### BACKGROUND

Machine-to-Machine (M2M) Communication is a form of data communication between entities that, when deployed, do not necessarily require direct human interaction. One challenge of M2M Communication is establishing a protocol so that that deployed equipment may be managed efficiently.

M2M technologies have enabled various applications in different areas such as system status monitoring; automatic energy metering, home automation, wireless monitoring in intelligent buildings, personal area networks, monitoring of parameters, positioning, and real time location in medical technology, among other things.

Semantic Web

The Semantic Web is an extension of the Web through standards by the World Wide Web Consortium (W3C). The standards promote common data formats and exchange protocols on the Web, most fundamentally the Resource Description Framework (RDF).

The Semantic Web involves publishing in languages specifically designed for data: Resource Description Framework (RDF), Web Ontology Language (OWL), and Extensible Markup Language (XML). These technologies are combined to provide descriptions that supplement or replace the content of Web documents via web of linked data. Thus, content may manifest itself as descriptive data stored in Web-accessible databases, or as markup within documents, particularly, in Extensible HTML (XHTML) interspersed with XML, or, more often, purely in XML, with layout or rendering cues stored separately.

The Semantic Web Stack

The Semantic Web Stack illustrates the architecture of the Semantic Web specified by W3C, as shown in FIG. 1. The functions and relationships of the components can be summarized as follows.

XML provides an elemental syntax for content structure within documents, yet associates no semantics with the meaning of the content contained within. XML is not at present a necessary component of Semantic Web technologies in most cases, as alternative syntaxes exist, such as Turtle. Turtle is a de facto standard, but has not been through a formal standardization process. XML Schema is a language for providing and restricting the structure and content of elements contained within XML documents.

RDF, a framework for representing information in the Web. RDF is essentially a data-model. Its basic building block is a subject-predicate-object triple, called a statement. The subject defines the resource that the statement is about. The predicate (or relationship) defines the relationship between the subject and object. The object defines the resource or value that is the object of the statement.

In the example shown in FIG. 2, the RDF statement could be written as follows in Turtle syntax (RDF 1.1 Turtle, http://www.w3.org/TR/turtle/#language-features), which means that John Smith's title is Professor. All the information using RDF model is represented in the format of RDF statement, i.e., RDF triple.

:JohnSmith (subject):hasTitle (predicate/relationship):Professor (object)

RDF Schema (RDFS) extends RDF and is a vocabulary for describing properties and classes of RDF-based resources, with semantics for generalized-hierarchies of such properties and classes.

OWL adds more vocabulary for describing properties and classes to improve the expressivity in contrast to RDFS: among others, relations between classes (e.g. disjointness), cardinality (e.g. “exactly one”), equality, richer type of properties, characteristics of properties (e.g. symmetry), and enumerated classes.

SPARQL is a protocol and query language for semantic web data sources, to query and manipulate RDF graph content (i.e. RDF triples) on the Web or in an RDF store (i.e. a Semantic Graph Store).

SPARQL 1.1 Query, a query language for RDF graph, can be used to express queries across diverse data sources, whether the data is stored natively as RDF or viewed as RDF via middleware. SPARQL contains capabilities for querying required and optional graph patterns along with their conjunctions and disjunctions. SPARQL also supports aggregation, subqueries, negation, creating values by expressions, extensible value testing, and constraining queries by source RDF graph. The results of SPARQL queries can be result sets or RDF graphs.

SPARQL 1.1 Update is an update language for RDF graphs. It uses a syntax derived from the SPARQL Query Language for RDF. Update operations are performed on a collection of graphs in a Semantic Graph Store. Operations are provided to update, create, and remove RDF graphs in a Semantic Graph Store.

RIF is the W3C Rule Interchange Format. It's an XML language for expressing Web rules that computers can execute. RIF provides multiple versions, called dialects. It includes a RIF Basic Logic Dialect (RIF-BLD) and RIF Production Rules Dialect (RIF PRD).

RDFS and OWL Reasoning

RDFS extends RDF by defining some more vocabularies (e.g., subClassOf, subPropertyOf) that can be used in RDF document. This means we can exploit some of the RDFS constructs to derive new information. Table 1 lists some examples of RDFS reasoning rules, which defines logic based on RDFS vocabulary in RDF triples.

TABLE 1
Example of RDFS Reasoning Rules (RDFS Inference)

| Num- | | |
|---|---|---|
| ber | Antecedent (If . . .) | Consequent (Then . . .) |
| 1 | p rdfs:domain x <RDF triple> | s rdf:type x <RDF triple> |
| | s p y<RDF triple> | |
| 2 | p rdfs:range o <RDF triple> | v rdf:type o <RDF triple> |
| | s p v <RDF triple> | |
| 3 | c rdfs:subClassOf c1 <RDF triple> | c rdfs:subClassOf |
| | c1 rdfs:subClassOf c2 <RDF triple> | c2 <RDF triple> |
| 4 | p rdf:subPropertyOf p1 <RDF triple> | p rdf:subPropertyOf |
| | p1 rdf:subPropertyOf p2 <RDF | p2 <RDF triple> |
| | triple> | |

The general format of RDF triples are presented in the table. For example, u s y is a RDF triple, where subject u, predicate s and object y could be any class, relationship or literal. Taking the number 3 RDFS rule as a real example, in an ontology, c could be defined as a class for dog, c1 could be defined as a class for mammal, and c2 could be defined as a class for animal. If class dog is defined as a subclass of class mammal, and class mammal is defined as a subclass of class animal, then it can be inferred that dog is a subclass of animal. This example could be written as follows in RDF triples with Turtle syntax:

@prefix rdf: <http://www.w3.org/1999/02/22-rdf-syntax-ns#> .
@prefix rdfs: <http://www.w3.org/2000/01/rdf-schema#> .
@prefix namespace1: <http://example.org/namespace1#> .

| | | |
|---|---|---|
| namespace1:dog | rdf:type | rdfs:Class |
| namespace1:mammal | rdf:type | rdfs:Class |
| namespace1:animal | rdf:type | rdfs:Class |

| | | |
|---|---|---|
| namespace1:dog | rdfs:subClassOf | namespace1:mammal |
| namespace1:mammal | rdfs:subClassOf | namespace1:animal |
| namespace1:dog | rdfs:subClassOf | namespace1: animal |

As mentioned earlier, with RDF Schema (RDFS) it is possible to define only relations between the hierarchy of the classes and properties, or define the domain and range of these properties. OWL is defined for more complex ontologies with richer vocabulary, and it enables more complex reasoning than RDFS. Table 2 lists some examples of OWL reasoning rules, which defines logic based on OWL vocabulary. The second column specifies the conditions (facts), and the third column indicates the conclusion if all facts in the second column take place. For example as the number 3 rule, if v is defined as a general owl:Class, and class v equals to class w, then it could be concluded that class v is a subclass of class w.

TABLE 2
Examples of OWL Reasoning Rules (OWL Inference)

| Num- | | |
|---|---|---|
| ber | Antecedent (If . . .) | Consequent (Then . . .) |
| 1 | p rdf:type owl:TransitiveProperty | u p v <RDF triple> |
| | <RDF triple> | |
| | u p w <RDF triple> | |
| | w p v <RDF triple> | |
| 2 | p rdf:type owl:SymmetricProperty | u p v <RDF triple> |
| | <RDF triple> | |
| | v p u <RDF triple> | |
| 3 | v rdf:type owl:Class <RDF triple> | v rdfs:subClassOf |
| | v owl:sameAs w <RDF triple> | w <RDF triple> |
| 4 | v rdf:subPropertyOf w <RDF triple> | v owl:equivalentProperty |
| | w rdf:subPropertyOf v <RDF triple> | w <RDF triple> |

Reasoning Rule Language

The Semantic Web Rule Language (SWRL) is a proposed language for the Semantic Web that can be used to express rules as well as logic, combining OWL DL or OWL Lite with a subset of the Rule Markup Language. SWRL is standardized by W3C.

The Rule Interchange Format (RIF) is a W3C Recommendation. RIF is part of the infrastructure for the semantic web, along with (principally) SPARQL, RDF and OWL. Although originally envisioned by many as a “rules layer” for the semantic web, in reality the design of RIF is based on the observation that there are many “rules languages” in existence, and what is needed is to exchange rules between them.

RIF includes three dialects, a Core dialect which is extended into a Basic Logic Dialect (BLD) and Production Rule Dialect (PRD).

oneM2M Architecture

The oneM2M standard (oneM2M-TS-0001 oneM2M Functional Architecture—V2.5.0) under development defines a Service Layer called “Common Service Entity (CSE)”. The purpose of the Service Layer is to provide “horizontal” services that can be utilized by different “vertical” M2M systems and applications.

The CSE supports four reference points as shown in FIG. 3. The Mca reference point interfaces with the Application Entity (AE). The Mcc reference point interfaces with another CSE within the same service provider domain and the Mcc′ reference point interfaces with another CSE in a different service provider domain. The Men reference point interfaces with the underlying Network Service Entity (NSE). An NSE provides underlying network services to the CSEs, such as device management, location services and device triggering.

CSE contains multiple logical functions called “Common Service Functions (CSFs)”, such as “Discovery”, “Data Management & Repository”. FIG. 4 illustrates the CSFs under development at oneM2M.

Functional Architecture of M2M Semantics Support

FIG. 5 shows a proposed functional/logical architectural for M2M semantic support. The major components may include data repository 201, ontology repository 202, ontology modeling and processing 203, semantics repository 204, or reasoning 200, among others.

Data Repository 201 basically includes new data. In addition, it also provides functions to support the search, modification and deletion of the stored data.

Ontology Repository 202 includes ontologies. Ontology is a formal specification of a conceptualization that is defining concepts as objects with their properties and relationships versus other concepts. Therefore, Ontology can be defined as a linguistic artifact that defines a shared vocabulary of basic concepts for discourse about a piece of reality (subject domain) and specifies those concepts including operations.

Ontology Modelling and Processing 203—Ontology modeling is the process for building an ontology which is used to model a domain and support reasoning about concepts. Examples of languages for ontology modeling are XML-based RDF, RDF Schema (RDFS), OWL, etc. Ontology Processing is the process of classifying, storing, and providing discovery function of published/modeled ontologies external and internal of the M2M domain. The ontologies are converted and stored in Ontology repository in a unified language (e.g. RDFS/OWL) that can be shared and used to enable semantics to resources.

Semantics Repository 204 includes annotated semantics information in certain representations, which may have the option of utilizing RDF. Semantics annotation is a process of representing resource's semantics in a concrete format, such as binary stream.

Semantic Annotation of M2M resources is a method for adding semantic information to M2M resources so that it provides consistent data translation and data interoperability to heterogeneous M2M applications. Semantically annotated M2M resources maintained in the semantic repository can be contacted by an M2M application that understands what data are provided by the resources and what these data means. These annotations provide more meaningful descriptions and expose M2M data than traditional M2M system alone.

Reasoning 200 is a mechanism to derive a new implicit knowledge from semantically annotated data and to answer complex user query. It can be implemented as a piece of software to be able to infer logical consequences from a set of asserted facts or axioms.

Semantic Analysis and Query 206—in semantic analysis and query, the requests from an M2M application are analyzed semantically. Based on the analysis, it creates semantic query messages and sends the messages to functional components (e.g. ontology repository, reasoning, semantic mash-up, etc.) in abstraction and semantics for requesting semantic information. After obtaining the requested information, it responds to the M2M application.

Semantic Description in oneM2M Architecture

The <semanticDescriptor> resource is used to store a semantic description pertaining to a resource and potentially other semantically related resources. Such a description is provided according to ontologies. The semantic information is used by the semantic functionalities of the oneM2M system and is also available to applications or CSEs. Currently the <semanticDescriptor> resource could be a child resource under <AE>, <container>, <contentlnstance>, <group> and <node> resources.

The <semanticDescriptor> resource contains the attributes specified in Table 3 (without listing common and universal attributes defined in oneM2M-TS-0001 oneM2M Functional Architecture—V2.5.0).

TABLE 3
Attributes of <semanticDescriptor> Resource

| | | RW/ | |
|---|---|---|---|
| Attributes of | Multi- | RO/ | |
| <semanticDescriptor> | plicity | WO | Description |
| Creator | 0 . . . 1 | RO | The AE-ID of the entity |
| | | | which created the resource. |
| | | | This can also be the CSE- |
| | | | ID of the IN-CSE if the |
| | | | IN-CSE created the resource. |
| Descriptor | 1 | RW | store a semantic description |
| | | | pertaining to a resource and |
| | | | potentially sub-resources. |
| | | | Such a description may be |
| | | | provided according to ontol- |
| | | | ogies. Currently, the format |
| | | | of semantic information in |
| | | | this attribute is RDF triples |
| | | | since RDF is assumed as the |
| | | | default data model used by |
| | | | oneM2M community. |
| ontologyRef | 0 . . . 1 | WO | A reference uniform resource |
| | | | identifier (URI) of the |
| | | | ontology used to represent the |
| | | | information that is stored in |
| | | | the descriptor attribute. If |
| | | | this attribute is not present, |
| | | | the ontologyRef from the parent |
| | | | resource is used if present. |

Semantic Filtering Proposals in oneM2M

Generic filtering is supported by having filter criteria specified in a request operation (oneM2M-TS-0001 oneM2M Functional Architecture—V2.5.0—section 8.1.2). In order to provide for semantic filtering, an additional value for the request operation filter criteria has been proposed in oneM2M TR-0007-Study_on_Abstraction_and_Semantics_Enablement—V2.6.0—section 8.5.4, with the definition shown in the table below. Multiple instances may be used, in which case a logical “OR” applies between instances, i.e. the overall result for the semantics filter criteria is true if one or more of the semantic filters matches the semantic description.

TABLE 4
‘semantics’ Attribute in Filter Criteria

| | | |
|---|---|---|
| Semantics | 0 . . . n | The semantic description contained in one of the |
| | | <semanticDescriptor> child resources matches the |
| | | specified semantic filter. |

The proposal above uses the following assumptions: the semantic descriptions are specified as RDF triples (representation, e.g. RDF/XML, Turtle, description format had not been fully specified in oneM2M yet); the semantics filter criteria will be used for SPARQL requests to be executed on semantic descriptions.

Base Ontology in oneM2M and Ontology Mapping

Currently, oneM2M is defining a base ontology. The base ontology is the only ontology that oneM2M will standardizes, and is the minimal ontology (i.e. mandating the least number of conventions) that is required such that other ontologies can be mapped into oneM2M. The main purpose of base ontology is to enhance the interoperability. Any external ontology could be published to the oneM2M service layer, and be mapped to the base ontology. It is the publisher's responsibility to do the mapping between the external ontology and the base ontology. There are some mapping principles defined in oneM2M TS-0012—Base Ontology—V0.6.0.

The ontology is relatively static, i.e., it is rarely changed once it is defined and published to the M2M system. An application could know an ontology through ontology discovery process.

Semantic Reasoning in oneM2M Semantics Framework

In oneM2M TR-0007-Study_on_Abstraction_and_Semantics_Enablement—V2.6.0, semantic reasoning is defined as a mechanism to derive a new implicit knowledge from semantically annotated data and to answer complex user query. It can be implemented as a piece of software to be able to infer logical consequences from a set of asserted facts or axioms. In addition, some requirements are identified for implementing semantic reasoning within oneM2M semantic framework.

TABLE 5
Requirements for Semantic Reasoning

| Number | Requirements |
|---|---|
| 1 | The M2M system shall be able to update ontologies as a result |
| | of the ontology reasoning. |
| 2 | The M2M System shall be able to support semantic reasoning |
| | e.g. ontology reasoning or semantic rule-based reasoning. |
| 3 | The M2M System shall be able to support adding and updating |
| | semantic information based on semantic reasoning. |

### Definitions

Entailment: A deduction or implication, that is, something that follows logically from or is implied by something else.

Semantic reasoning: A mechanism to derive a new implicit knowledge from semantically annotated data and to answer complex user query. It can be implemented as a piece of software to be able to infer logical consequences from a set of asserted facts or axioms. A semantic reasoning rule defines some logic that could be used to derive some new knowledges based on existing information. Semantic rules concentrate on defining a general mechanism on generating new relationships based on existing concepts and relationships in ontologies using logical manners.

Semantic annotation: A method for adding semantic information (i.e., metadata, RDF triples) to the original information (e.g., M2M resources in oneM2M) for providing consistent data translation and data interoperability to heterogeneous M2M applications.

Ontology: A formal specification of a conceptualization (vocabulary) that is defining concepts as objects with their properties and relationships versus other concepts. Ontologies concentrate on classification methods, putting an emphasis on defining ‘classes’, ‘subclasses’, on how individual resources can be associated to such classes, and characterizing the relationships among classes and their instances.

Ontology Repository: Storage data base of ontologies.

Semantic Graph Store: A data base storing the semantic information. Specifically, if RDF data model is used, then it is TripleStore storing RDF triples.

### SUMMARY

Semantic reasoning provides the capability of extracting new information based on existing information relying on the defined reasoning rules, and thus enabling interoperability among different domains (e.g., smart home, smart transportation and environment monitoring). However, how to enable the semantic reasoning capability at M2M/IoT service layer is not defined yet.

This disclosure defines mechanisms for enabling semantic reasoning service within the semantic framework in a M2M/IoT system. The following are disclosed: 1) an overall architecture of semantic reasoning processor, which highlights the functional components and flows of the reasoning process; 2) procedures for reasoning rule management in M2M/IoT systems (e.g., create and delete) are defined for different scenarios; 3) procedures for triggering and performing the semantic reasoning process in M2M/IoT systems, which may be triggered by semantic query and semantic annotation process in on-demand and proactive manner; and 4) methods of dealing with and processing the new information generated through semantic reasoning process, which may include generating more semantic information to describe the information generated (e.g., new data content).

Also disclosed herein are new resources, attributes and message formats showing how to apply the associated semantic reasoning to a oneM2M resource oriented architecture (ROA).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 illustrates an architecture of the semantic web;

FIG. 2 illustrates an example of RDF graph;

FIG. 3 illustrates oneM2M architecture;

FIG. 4 illustrates oneM2M common service functions;

FIG. 5 illustrates functional architecture of M2M semantic support;

FIG. 6 illustrates structure of <semanticDescriptor> resource;

FIG. 7 illustrates an exemplary method for enabling semantic reasoning within M2M service layer semantic framework;

FIG. 8A illustrates an exemplary ontology for a smart building;

FIG. 8B illustrates exemplary light domain ontology of FIG. 8A;

FIG. 9 illustrates an exemplary ontology of a light domain;

FIG. 10 illustrates an exemplary method for enabling semantic reasoning within M2M service layer semantic framework;

FIG. 11 illustrates an exemplary ontology;

FIG. 12 illustrates an example of instructions to facilitate a semantic query;

FIG. 13 illustrates an exemplary functional architecture of semantic reasoning in an M2M system;

FIG. 14 illustrates an exemplary method for rule management and semantic reasoning process;

FIG. 15 illustrates an exemplary method of creating a Type 2 reasoning rule when a new ontology is published and stored in the M2M system;

FIG. 16 illustrates an exemplary method of creating a Type 2 reasoning rule when an ontology is updated;

FIG. 17 illustrates an exemplary method for deleting a reasoning rule when an ontology is updated;

FIG. 18 illustrates an exemplary method of a semantic reasoning process triggered by a semantic query process;

FIG. 19 illustrates an exemplary method of a semantic reasoning process which is triggered by semantic annotation process;

FIG. 20 illustrates an exemplary method for processing new information generated via a reasoning process;

FIG. 21 illustrates an exemplary oneM2M CSE with semantic reasoning;

FIG. 22 illustrates an exemplary user interface associated with semantic reasoning as a service;

FIG. 23 illustrates an exemplary display (e.g., graphical user interface) that may be generated based on the methods and systems of enabling a semantics reasoning service, as discussed herein;

FIG. 24A is a system diagram of an example machine-to-machine (M2M) or Internet of Things (IoT) communication system in which the disclosed subject matter may be implemented;

FIG. 24B is a system diagram of an example architecture that may be used within the M2M/IoT communications system illustrated in FIG. 24A;

FIG. 24C is a system diagram of an example M2M/IoT terminal or gateway device that may be used within the communications system illustrated in FIG. 24A; and

FIG. 24D is a block diagram of an example computing system in which aspects of the communication system of FIG. 24A may be embodied.

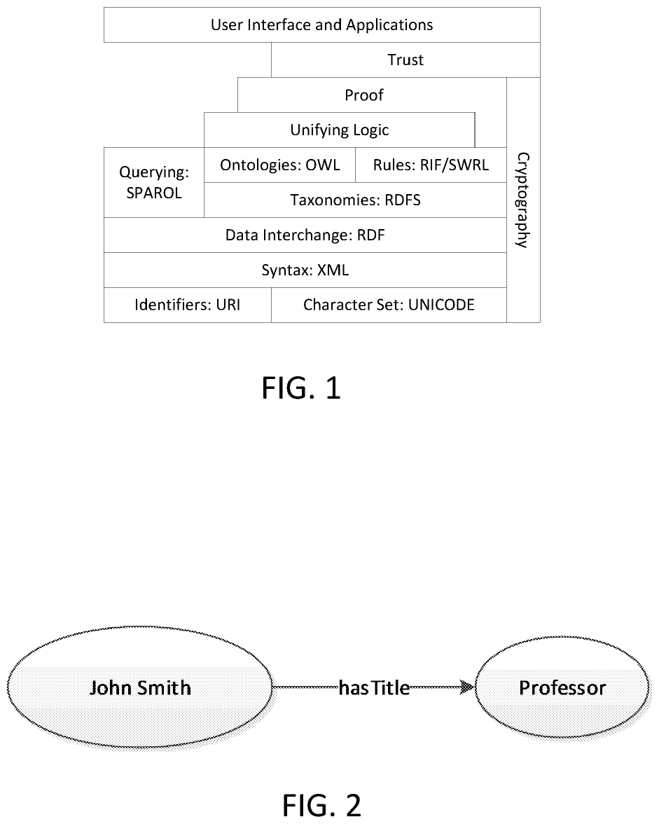

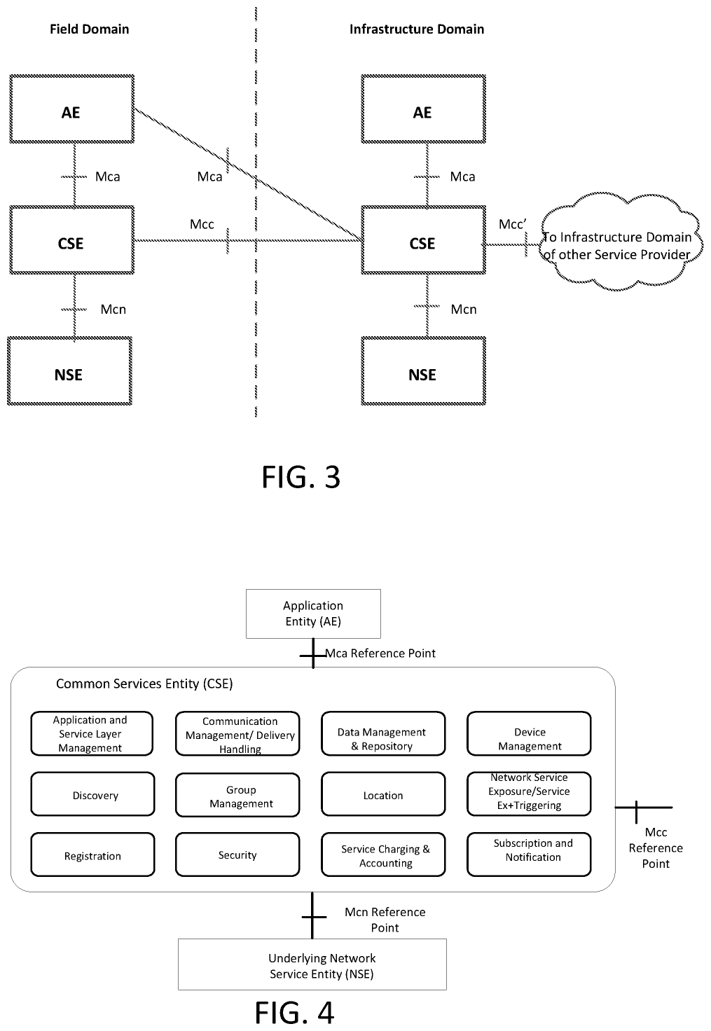

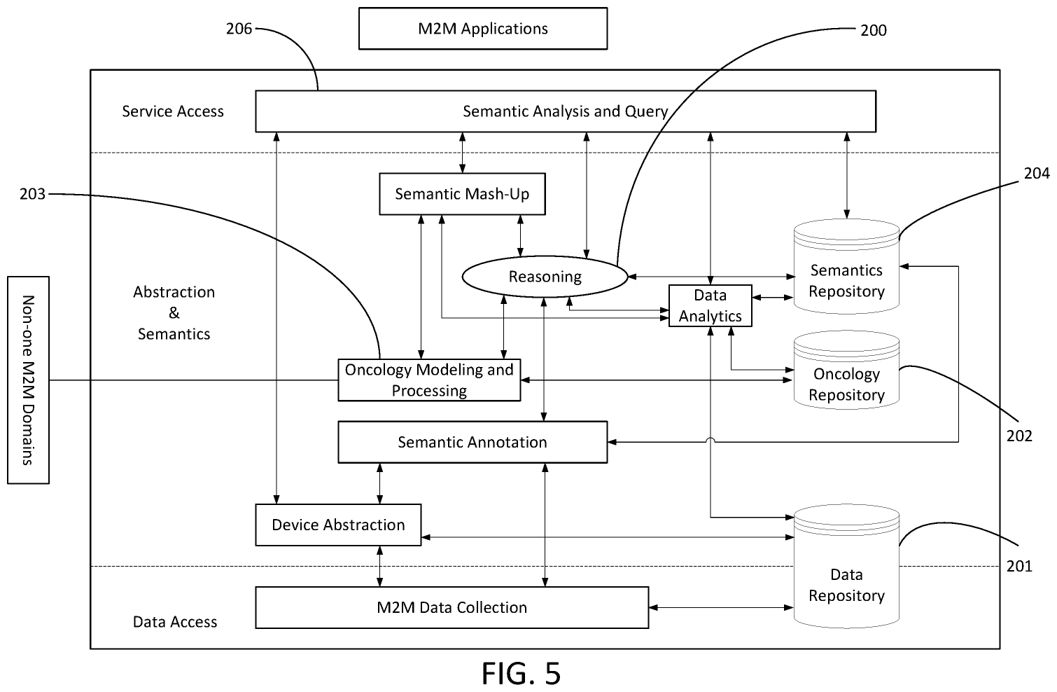

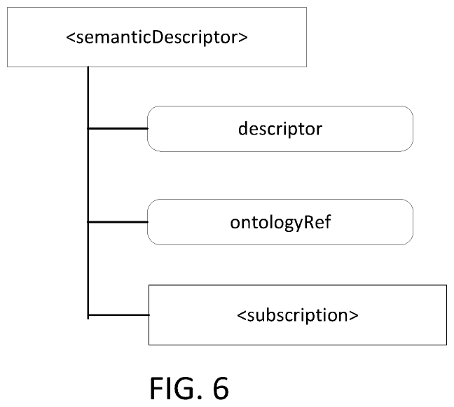

### DETAILED DESCRIPTION OF ILLUSTRATIVE EMBODIMENTS

Disclosed herein are mechanisms for enabling semantic reasoning service within the semantic framework in a M2M/IoT system. Discussed below are scenarios that provide additional perspective with regard to the disclosed semantic reasoning service.

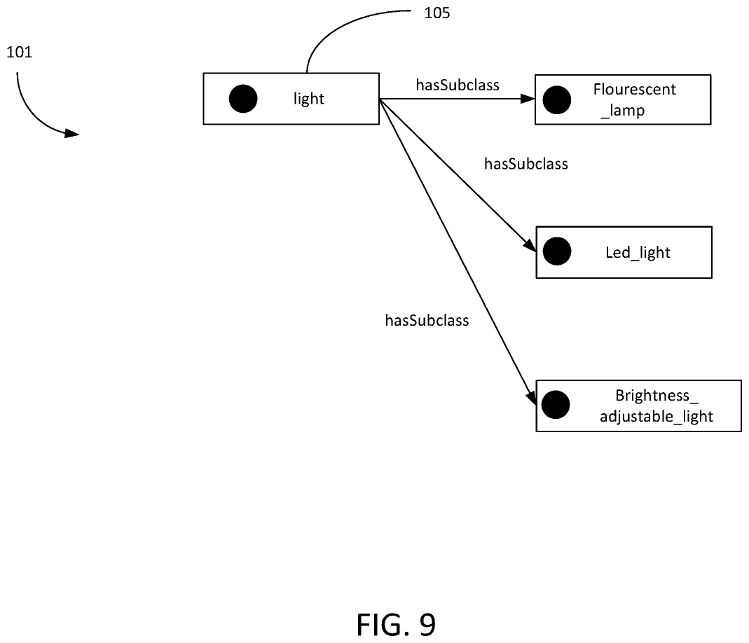

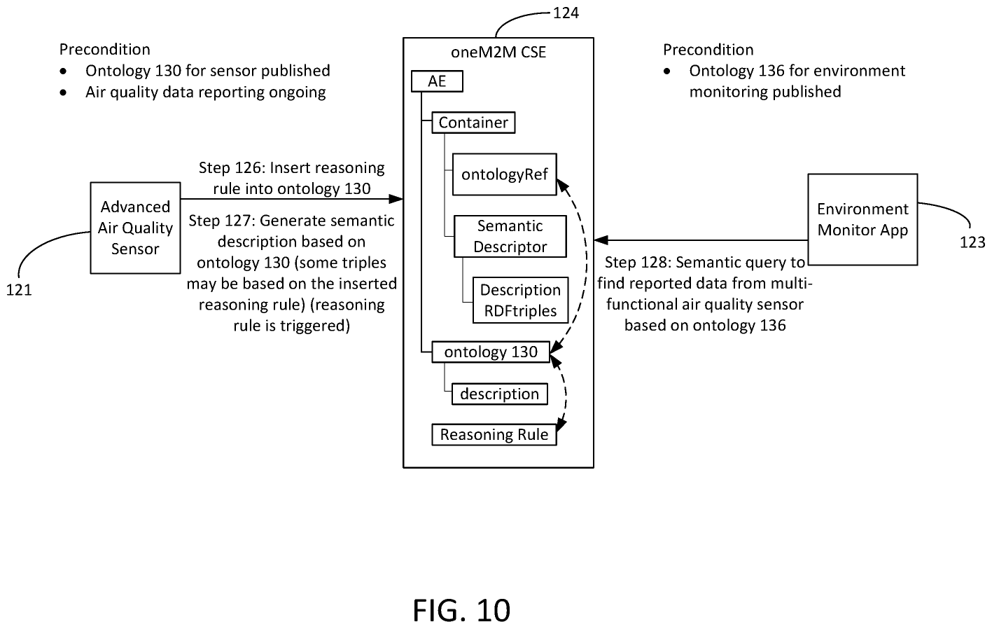

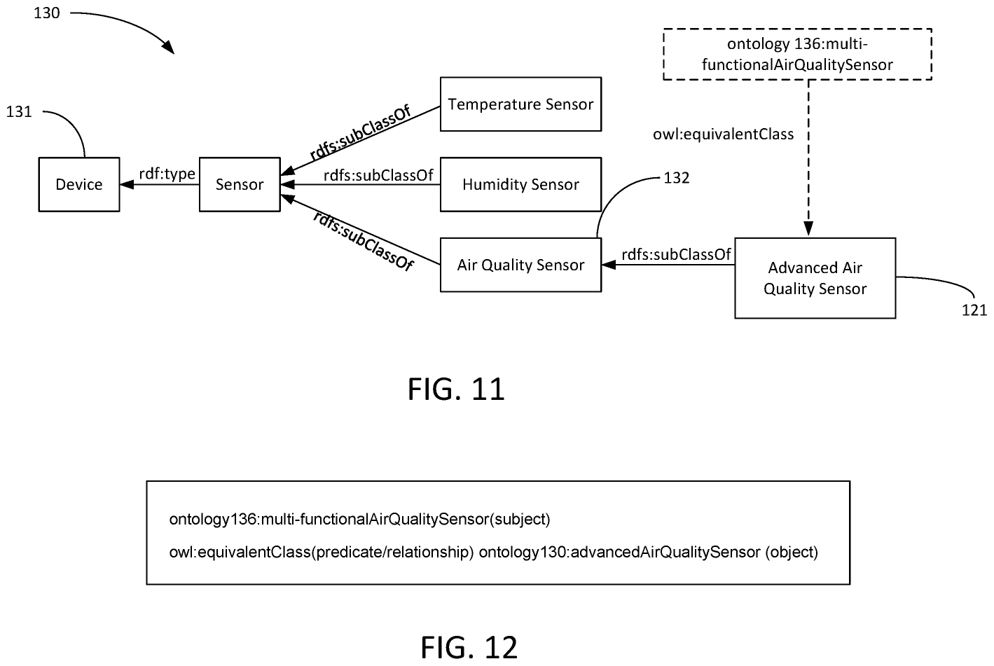

With reference to a first scenario, FIG. 7 illustrates flows that describe a process of semantic query initiated by light control application 106 that defines ontology 101 of FIG. 9. As discussed in more detail below, light control application 106 with ontology 101 may not receive accurate information with regards to lights 103 defined by ontology 100 of FIG. 8B if the reasoning capability is not triggered or enabled. Disclosed herein are methods of how and when to trigger the reasoning and perform the reasoning process, which is not defined in conventional machine-to-machine (M2M) systems. The rules used by the reasoning process may be managed and used by the sematic query process to assist in obtaining more accurate results.

For further perspective below is a narrative of an exemplary scenario that is disclosed in more detail herein. There are many lights in the building. These lights installed in the building are controlled by smart building app 104, which defines a smart building ontology 100 as shown in FIG. 8 covering not only devices for lights (also referred to as lights herein) also some other devices in the building. Later on, light control app 106 attempts to update the LED lights (adjustable or dimmable), for example, update the firmware/software. Since light control app 106 is specific to the light domain, it may not be aware that there is already an ontology defined by smart building app 104, light control app 106 will use its own language (i.e., ontology). Therefore, it defines another ontology as shown in FIG. 9. To update the target lights, an initial step is to find the LED lights (e.g., all LED lights in this scenario, but contemplated LED lights of a certain type or the like). Different terms are used in the two ontologies (e.g., brightness adjustable is a Boolean attribute in smart building ontology vs Brightness_adjustable_light is a subclass of light). Without reasoning, oneM2m CSE 124 may not be able to find some lights, since the query from light control app 106 is in light control ontology 105, while the RDF triples representing other light are in smart building app 104 created by the smart building app 104. Therefore, reasoning should be used to find the other lights.

A method of FIG. 7 may be as follows. As shown there is communication among smart building app 104, oneM2M CSE 124, and light control app 106. At step 110, smart building app 104 may send a message for defining smart building ontology 100 as shown in FIG. 8A. At step 111, light control app 106 may send a message for defining ontology 101 with regard to the light domain. At step 112, smart building app 104 may send a message that creates RDF triples via semantics annotation according to ontology 100 with metadata of lights in the building. At step 113, light control app 106 may initiate semantics query based on ontology 101 to find LED and adjustable lights (reasoning should be triggered) over RDF triples inserted by smart building app 104. At step 114, oneM2M CSE 124 returns those led adjustable lights as response to the query from light control app 106 once the reasoning is applied.

The first scenario is in the context of a semantics smart building light control. FIG. 8A illustrates an exemplary ontology 100 for things in a smart building (e.g., floor, room, light, or sensor), where light 103 is defined as a subclass of device 102 and smart building application 104 of FIG. 7 defines ontology 100 of FIG. 8A and FIG. 8B. FIG. 8A illustrates part of the ontology 101. In the first scenario, light control application 106 may define an ontology 101 for light 105, which is shown in FIG. 9. In order to save power, light control application 106 may determine whether to adjust the brightness of some lights instead of switching on more lights. LED light may be preferred and there may be a preference that the selected light be a brightness_adjustable light as well. Therefore, light control application 106 that defines ontology 101 may initiate the semantic query first over the RDF triples that are annotated based on ontology 100. However, the ontology 100 does not explicitly specify if a light is a LED light and brightness_adjustable light. Ontology 100 only defines the property “kind” and “brightness_adjustable” to describe light 103; while LED light and brightness_adjustable_light are defined as two sub-classes of light 105 in ontology 101. In conventional systems this different vocabulary may prevent light control application 106, which defines ontology 101, from discovering desired lights 103 in the smart building with lights 103 defined by ontology 100.

With the help of semantic reasoning, reasoning rules may be defined as follows for facilitating the semantic query in Turtle format for a RDF triple:
1. {?light ontology100:kind “led”}=>{?light rdf: type ontology101:led_light}
2. {?light ontology100:brightness_adjustable true}=>{?light rdf: type ontology101:brightness_adjustable_light}

The first rule means that any light 103 (any string starting with a question mark is a variable) whose “kind” (as defined in ontology 100) is “led”, must also be “led_light” according to ontology 101. Note that a namespace (prefix) such as ontology 100 may be associated with the relationship “kind” in order to indicate that this relationship is defined within ontology 100. Other ontologies may define the same “kind” relationship but with different meaning. Similarly, the second rule provides that any light 103 whose attribute “brightness_adjustable” (based on ontology 100) is true, must be a “brightness_adjustable_light” in ontology 101.

In a second scenario, a service provider distributes many different types of sensors to provide environmental monitoring services with real-time temperature, humidity, air quality data, etc. Therefore, applications from different domains can get the latest information for different purposes. Travelers may get the latest temperature and humidity of their tour destination. Smart home appliances may get temperature and humidity to dynamically configure air conditioning. Or an environmental agency may retrieve the latest air quality data for the environment monitoring.

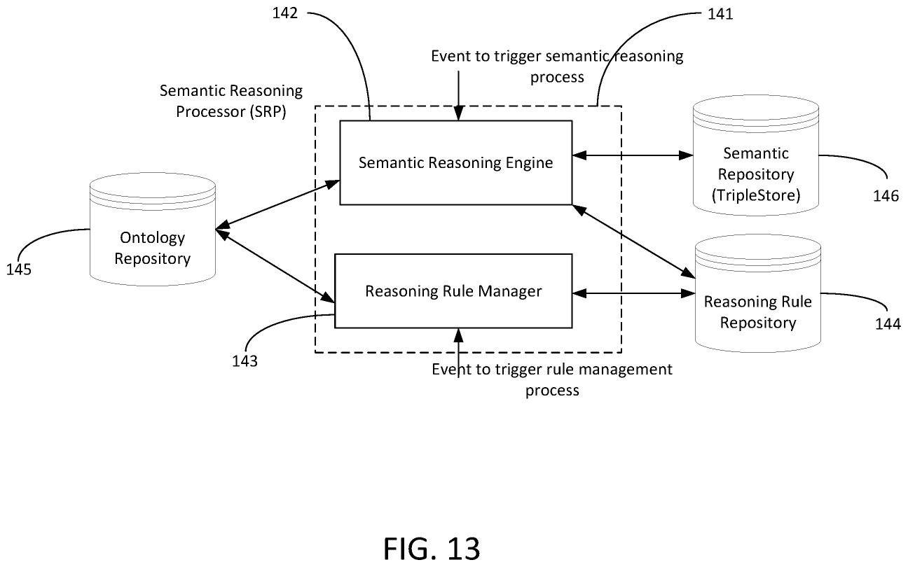

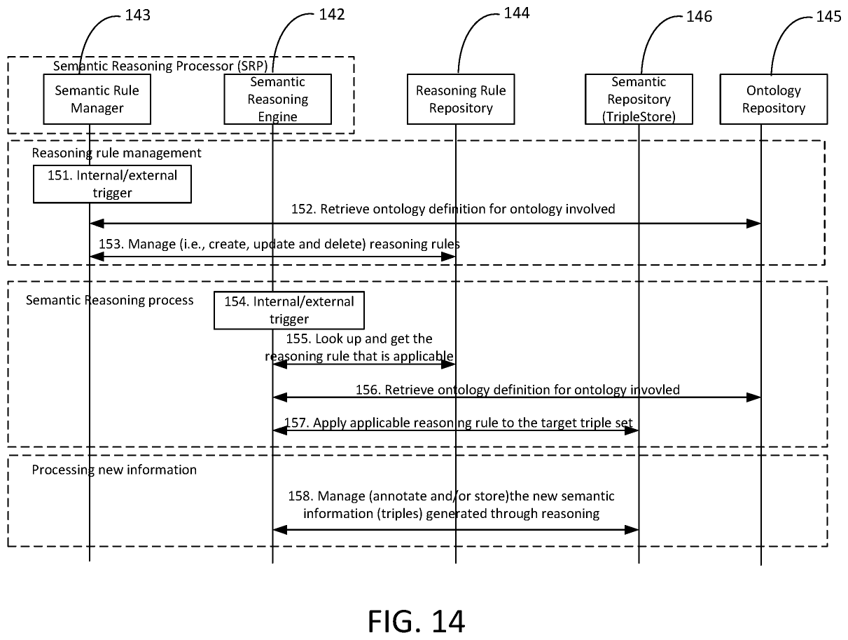

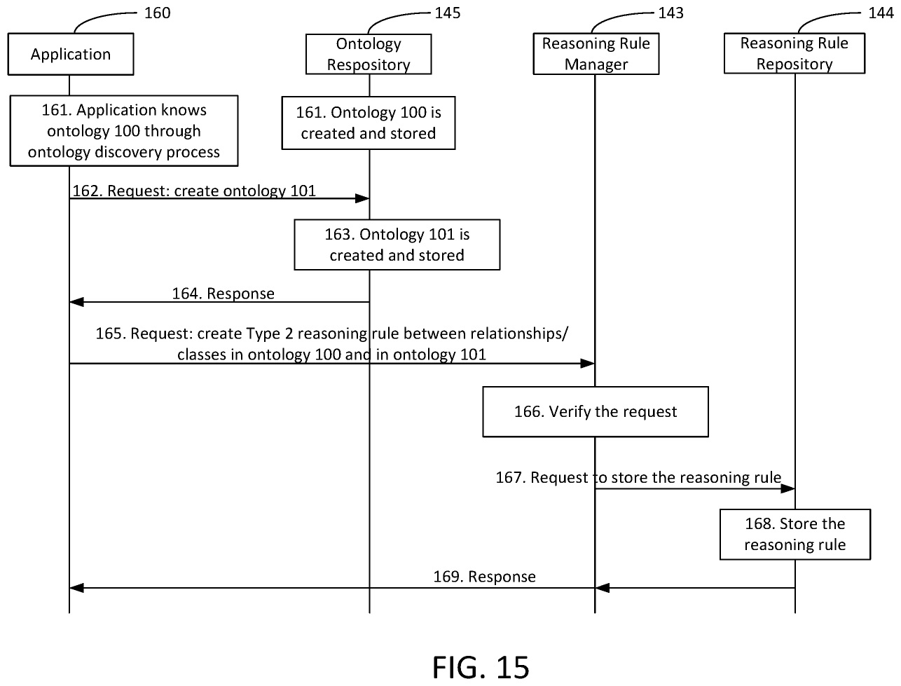

FIG. 10 illustrates an exemplary flow description based on the second scenario. As shown there is communication among advanced air quality sensor 121, oneM2M CSE 124, and environmental monitor application 123. At step 126, a reasoning rule may be inserted into ontology 130 of FIG. 11. At step 127, a semantic description may be generated based on ontology 130 (some triples may be based on the inserted reasoning rule—reasoning is triggered). At step 128, there may be a semantic query to find reported data from multi-functional air quality sensor based on ontology 136 of FIG. 12. At step 129, oneM2M CSE 124 returns the sensors as response to the query of step 128.

Semantic description is generated and appended when a sensor reports the latest measured sample based on the ontology 130 as shown in FIG. 11, which is defined by a service provider. For example, advanced air quality sensor 121 may be defined as a sub-class of air quality sensor 132. An advanced air quality sensor is defined as able to measure multiple toxic ingredients in the air, e.g., carbon monoxide (CO), carbon dioxide (CO2), and Nitrogen Dioxide.

With reference to FIG. 10, environment monitor application 123 may look for the sensors which are capable of measuring multiple toxic ingredients in the air. An ontology 136 (FIG. 11), which may be specialized for the environment monitoring domain, may define such sensor type as multi-functional (e.g., class ontology136:multi-functionalAirQualitySensor). To facilitate the semantic query from the environment monitor domain, additional information may be added to connect the two concepts between the respective ontologies. Specifically, owl:equivalentClass could be used in this example as shown in FIG. 12.

One way of integrating this information is to insert it into ontology 130 when ontology 136 is published to the M2M system, as shown in FIG. 11. FIG. 10 illustrates a flow where semantic reasoning is done in step 127, and semantic query (step 128) is performed over the semantic information generated in step 127. In conventional systems, there is no mechanism for defining how to trigger the insertion of the reasoning rule (step 126) and perform the reasoning (step 127) to generate more semantic information based on the reasoning rule. Some new semantic information will be inferred through reasoning process. For example, given the reasoning rule: {?light ontology130:kind “led”}=>{?light rdf:type ontology136:led_light}, if there is a light described based on ontology 130 as follows: lightA ontology130:kind “led”, then, there can be one more triple (semantic information): lightA rdf:type ontology136:led_light.

Below is additional discussion with regard to some issues associated with conventional semantic reasoning and querying systems. As illustrated in the first scenario and the second scenario above, to enable the semantic reasoning within the M2M service layer semantic framework, there is a configuration of reasoning rules. Conventional mechanisms have trouble doing the following: 1) organizing and structuring reasoning rules in order to efficiently utilize the semantic reasoning capability and affect the results of other processes (e.g., semantic query); and 2) dynamically managing reasoning rules in a way that reduces the effect of utilization of other semantic information and ontology.

For conventional systems, the lack of mechanisms for triggering and performing reasoning negatively impacts semantic functionality. In conventional systems, semantic query is widely considered as the main event or process that may trigger the semantic reasoning. Mechanisms for semantic reasoning in a proactive manner (e.g., triggered internally without any external trigger such as a semantic query) is not sufficiently defined in conventional systems. As discussed in more detail herein, semantic reasoning in a proactive manner may be helpful for: 1) when an application that is not aware of reasoning capability initiates a semantic query; and 2) when a set of semantic information is frequently queried—proactively running the reasoning process may save overhead based on repeating the same reasoning process. Different types of triggers are used herein that may result in different procedures and steps for performing the reasoning process than are in conventional systems. As shown in the light and sensor use cases, adding a new ontology or a new class may trigger creation of rules. The trigger could be semantic query request, so that reasoning process is triggered for discovering the desired information as discussed in the two use cases. This may be considered an example of an external trigger. For internal trigger, semantic annotation is an example. For example, with regard to internal trigger, when some RDF triples are created, then the reasoning process may be triggered proactively, and create another set of triples based on reasoning rules and the set of triples to be created.

With continued reference to issues associated with conventional semantic reasoning and querying systems, generally new information is generated through the semantic reasoning process. For example, in the second scenario associated with FIG. 10-FIG. 12, a new triple is generated to describe advanced air quality sensor 121 as a multi-functional air quality sensor according to the reasoning rule. However, in conventional systems, mechanisms of processing and storing newly generated information are not defined.

In view of the aforementioned issues and scenarios, the following are considered herein: 1) different reasoning rules that involve different ontology and relationships may be applied to the same set of triples, therefore, from the access control point of view, new information that is obtained through inference should not be stored together with the triples that were used to obtain the information; and 2) some new data content may be generated in addition to the metadata—since the data content is opaque, mechanisms of adding the metadata (e.g., annotate the content data) to make it understandable are preferred.

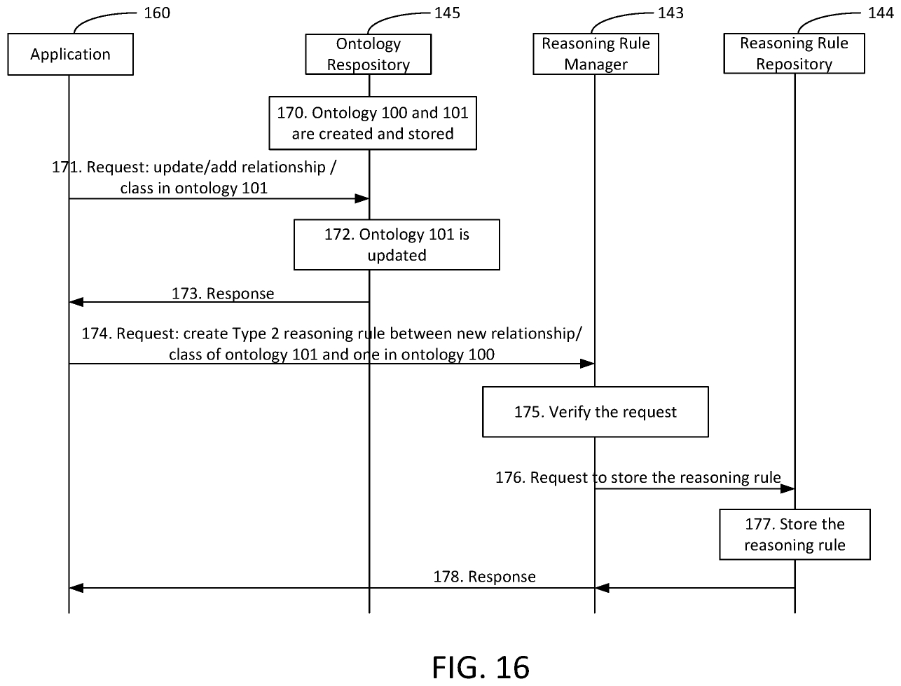

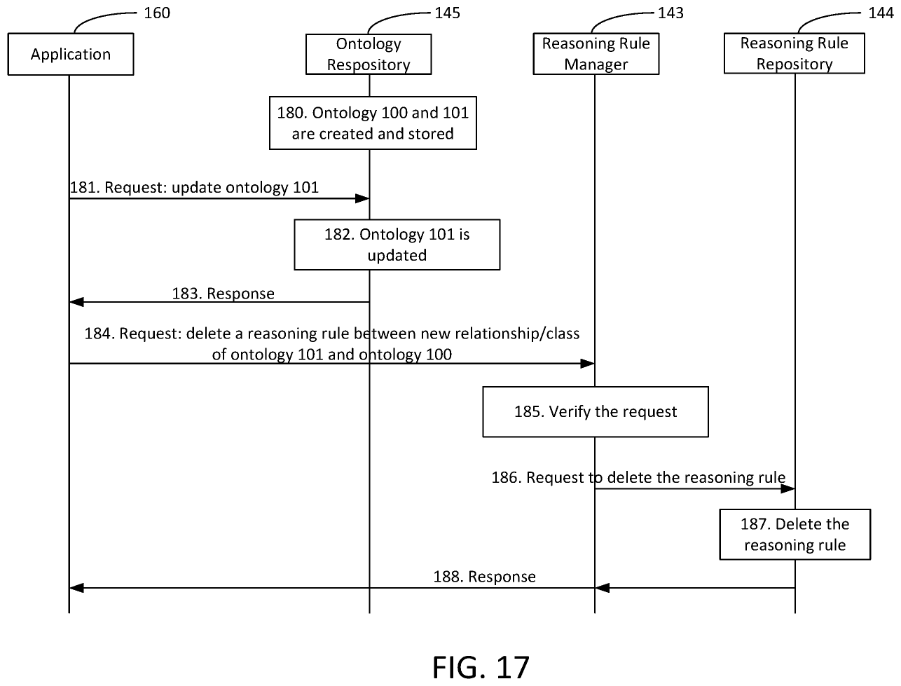

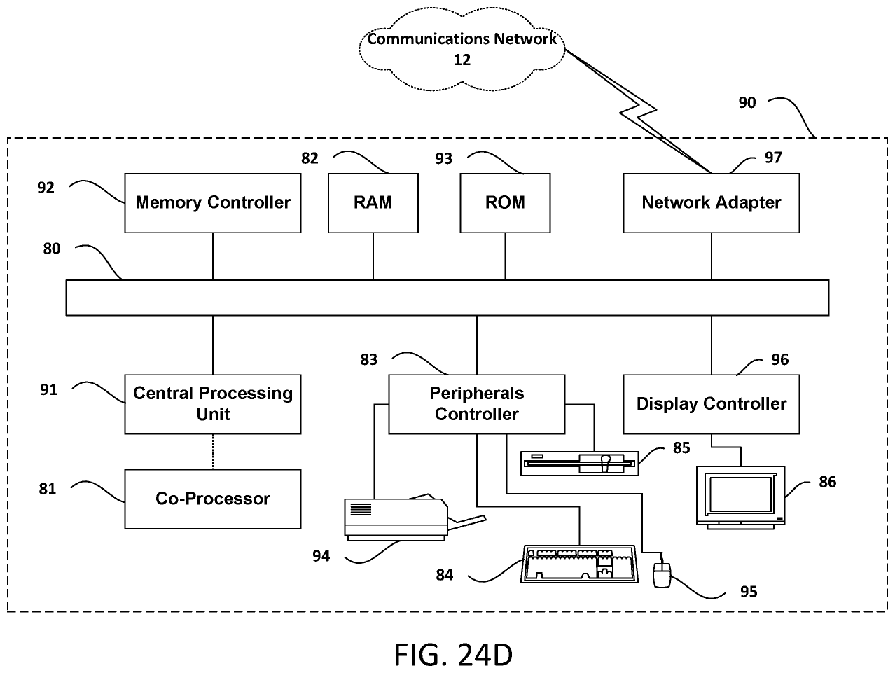

It is understood that the entities performing the steps illustrated herein, such as FIG. 7, 10, and FIG. 14-FIG. 20, may be logical entities. The steps may be stored in a memory of, and executing on a processor of, a device, server, or computer system such as those illustrated in FIG. 24C or FIG. 24D. In an example, with further details below with regard to the interaction of M2M devices, light control application 106 or smart building application 104 of FIG. 7 and application 160 may reside on M2M terminal device 18 of FIG. 24A, while semantic reasoning engine 142 and reasoning rule manager 143 of FIG. 13 may reside on M2M gateway device 14 of FIG. 24A. Skipping steps, combining steps, or adding steps between exemplary methods disclosed herein (e.g., FIG. 7, 10, and FIG. 14-FIG. 20) is contemplated.

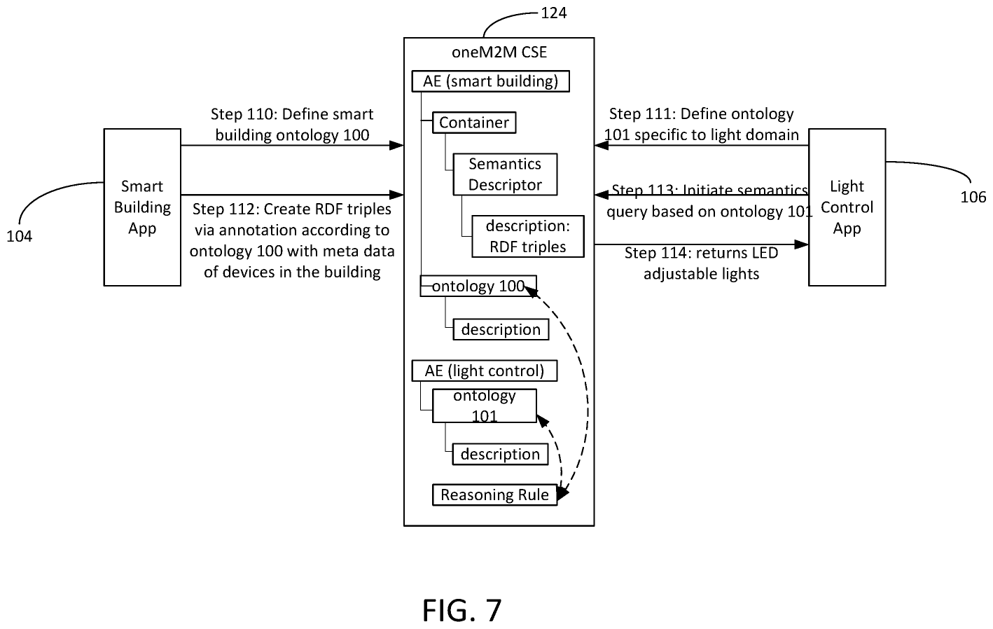

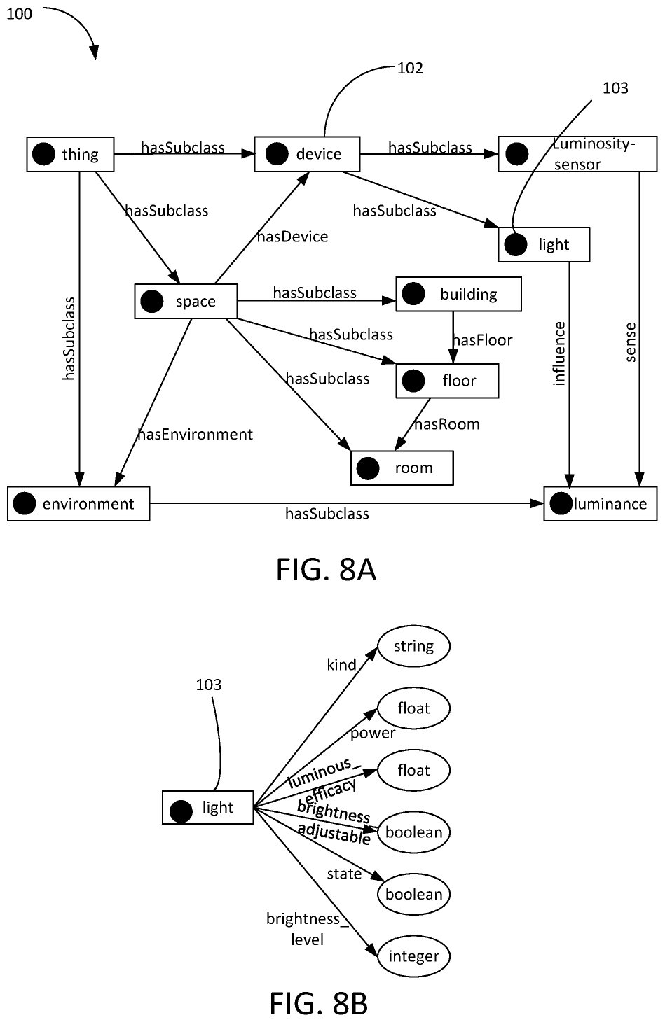

Discussed below are a functional architecture (FIG. 13) along with a method flow (FIG. 14) that highlights the semantic reasoning process within an M2M service layer system. The method flow includes several main procedures that are discussed in more detail below. FIG. 13 illustrates an exemplary functional architecture of a semantic reasoning processor (SRP) 141 in an M2M system. All or parts of SRP 141 may be included in reasoning block 200 shown in FIG. 5. SRP 141 may include semantics reasoning engine 142 and reasoning rule manager 143. Semantic reasoning engine 142 is responsible for performing the reasoning process by applying logic based on reasoning rules. Semantic reasoning engine 142 may obtain a reasoning rule from a reasoning rule repository, derive appropriate class/relationship in ontology definition from an ontology repository, and perform reasoning process (e.g., deduction and inference) on the targeted data set stored in the semantic repository. The trigger for the reasoning process may come from an internal entity or outside the reasoning processor, e.g., semantic query and semantic annotation process. This functionality will be discussed in more detail herein.

Reasoning Rule Manager 143 of SRP 141 is responsible for managing (e.g., create, update, or delete) the reasoning rules that are maintained in the reasoning rule repository used by the semantic reasoning process. Reasoning Rule Manager 143 may trigger the management procedures, based on external or internal events. This functionality will be discussed in more detail herein.

With continued reference to FIG. 13, reasoning rule repository 144 may be generally considered a place where reasoning rules are stored and maintained. Semantic reasoning engine 142 and reasoning rule manager 143 may retrieve the desired reasoning rule for rule management and performing reasoning process. Reasoning rule repository 144 may be centralized, distributed, or hybrid. In an example, reasoning rule repository 144 may be placed physically with ontology in ontology repository 145, or in a separate computing device.

FIG. 14 illustrates high level flows including several main procedures of semantic reasoning process. The method flows generally illustrate the interactions related to the reasoning process. Some method flows are implied or abstracted (e.g., ontology management in the ontology repository is not shown).

Reasoning rule management (step 151-step 153): At step 151, an internal or external triggering event is received by reasoning rule manager 143 to start the rule management process (create, delete, or update). At step 152, reasoning rule manager 143 then retrieves the ontology definition from ontology repository to verify the new rules. If verification passes, at step 153, then repository rule manager 143 requests to actually create, delete, or update the reasoning rule in reasoning rule repository 144.

Semantic reasoning process (step 154-step 157): At step, 154, an internal or external triggering event is received by semantic reasoning engine 142 to start the reasoning process (e.g., apply the logic defined by reasoning rule on a set of semantic information). Semantic reasoning engine 142 communicates with reasoning rule repository 144 (step 155) and communicates with ontology repository 145 (step 156) to find available reasoning rules. At step 157, semantic reasoning engine 142 sends request to semantic repository 146 to apply the reasoning rule on a targeted data set.

At step 158, after completion of the reasoning process, semantic reasoning engine 142 may send a request to semantic repository 146 to store the new semantic information generated through the reasoning process. Whether to do this depends on the configuration by application or M2M service layer system. Semantic repository 146 responds after storing the new information.

Discussed below is reasoning rule management. There may be different types of reasoning rules, such as type 1 or type 2. Type 1 reasoning rule defines logic between relationships or classes in the same ontology. For example, as illustrated in the first scenario associated with FIG. 7, if a LED light is brightness adjustable, then a Type 1 reasoning rule may be defined as follows: {?light rdf:type ontology101:led_light}=>{?light rdf:type ontology101:brightness_adjustable_light}. Type 2 reasoning rule defines logic between relationships or classes in different ontologies (two or more ontologies). For example, the reasoning rule presented in the first scenario associated with FIG. 7 is a Type 2 reasoning rule since it is across two different ontologies. Type 2 reasoning rule may be defined as follows: {?light ontology100:kind “led”}=>{?light rdf:type ontology101:led_light}.

Discussed below is the creation of a reasoning rule. Creating, as discussed here, does not necessarily mean that the M2M system creates the reasoning rule; instead the M2M system may create an entry to store the reasoning rule. The service layer entity in M2M system (e.g., CSE in oneM2M) may not be able to understand the underlying semantic syntax (e.g., RDF schema, classes and properties defined in RDF/RDFS), but the CRUD operations are performed to manage the reasoning rule within the M2M system.

There are multiples cases that may trigger the creation of a new reasoning rule. In case 1, a new ontology is published and stored in M2M system, and a new reasoning rule is created between the relationship/class in the new ontology and the relationship/class of an existing ontology in M2M system. In this case, the new reasoning rule may be Type 2. In case 2, a new relationship/class is defined in an existing ontology, and a new reasoning rule is created between this new relationship/class and an existing relationship/class. In this case, the new reasoning rule may be Type 1 or Type 2.

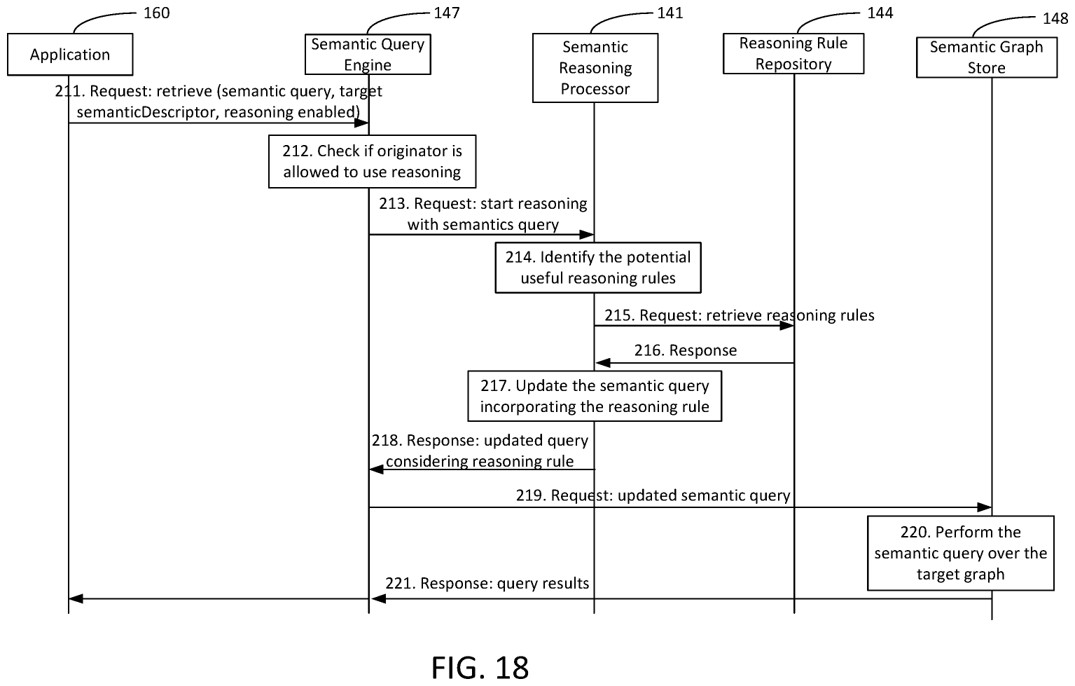

FIG. 15 illustrates an exemplary method of creating a Type 2 reasoning rule when a new ontology is published and stored in the M2M system (e.g., case 1). At step 161, ontology 100 is already stored in the M2M system. At the same time, application 160 discovers ontology 100 through the ontology discovery process (step 161). The ontology discovery process may be triggered when application 160 wants to figure out if it is possible to create some reasoning rules between ontologies, such as when application 160 wants to publish a new ontology to the M2M system. At step 162 through step 164, application 160 exchanges request and response messages with ontology repository 145 to publish and add a new ontology 101 into the M2M system. Particularly at step 162, application 160 may send a request message for creating ontology 101 to ontology repository. At step 163, ontology 101 is created. At step 164, a response message is sent to application 160, which may include a message that confirms the creation of ontology 101. The response of step 164 may include the reference (e.g., URL) to the ontology that is created and stored in the ontology repository 145.

At step 165, once application 160 gets the response confirming that ontology 101 has been successfully added to the M2M system, application 160 may send a request to reasoning rule manager 143 for creating a reasoning rule that establishes certain logical relations between ontology 100 and ontology 101. Parameters that may be included in the request message of step 165 may include reasoning rule type (Type 2 in this example), reference (e.g., URI) to the ontology (or ontologies), reasoning rule, format of the reasoning rule, or place to store the reasoning rule, among other things. Reasoning rule type indicates the type of reasoning rule to create in the request of step 165 and implies how many ontologies are involved. This provides a way of verification done by the reasoning rule manager 143, which compares the reasoning rule with the type and ontology involved. Reference to the ontology or ontologies provide a reference (e.g., URI) to access the ontology where the class/relationship involved in the reasoning rule is defined. Reasoning rule indicates the logic between class/relationship defined in one or two ontologies. Examples are presented with regard to the scenario associated with FIG. 7. Format of the reasoning rule indicates the format of representing the reasoning rule to help application 160 or other entity to understand and apply the reasoning rule. It may be a standard format (e.g., RIF) or non-standard format. Place to store the reasoning rule indicates where to store the reasoning rule. Reasoning rule repository 144 is a functional database, which means a reasoning rule may be actually stored in another physical database. If application 160 does not specify where to store the new reasoning rule, the rule manager may store the new rule in the default places. For example, a Type 1 reasoning rule may be stored in ontology repository 145 where the ontology is defined, since a Type 1 rule specifies some logic among class/relation in the same ontology. For a Type 2 reasoning rule which indicates logic relationships cross different ontologies, it could be stored within reasoning rule repository 144. Where to create and maintain the reasoning rule is usually up to reasoning rule manager 143.

With reference to step 165, an alternative way may be implemented to combine the request of step 165 with the request sent out in step 162. Application 160 may request for publishing an ontology and creating a reasoning rule into the system by sending one request message. In that case, ontology repository 145 may send a request directly to reasoning rule manager 143 for creating a new rule in reasoning rule repository 144.

At step 166, reasoning rule manager 143 may verify the request of step 165 before creating the new reasoning rule. Verification may include a check of the following: if application 160 is allowed to create a reasoning rule, if the classes or relation is valid in the reference ontology, or if the desired place to store the reasoning rule is valid and accessible, among other things. At step 167, based on the verification passing, reasoning rule manager 143 sends the request to reasoning rule repository 144 to create the new reasoning rule. The request message carries one or more of the contents and parameters included in the request of step 165. At step 168, the new reasoning rule may be created and stored in reasoning rule repository 144. At step 169, a response message may be returned to reasoning rule manager 143, as well as application 160, which initiated the request to create the new reasoning rule. In the response of step 169, a reference to the new reasoning rule may be included, so that reasoning rule manager 143 and application 160 (i.e., originator in this case) may access the rule for other operations, e.g., delete or disable. The reference may be a URI or a unique ID.

FIG. 15 is in reference to Type 2, but creating a Type 1 reasoning rule follows almost the same procedure with a few differences. A first difference is that ontology 100 is not necessarily pre-configured and stored in the system (e.g., step 161). More general, application 160 may not need to discover the ontology 100 since Type 1 reasoning rule reveals relation within one ontology. A second difference is that the parameters of the request message of step 165 includes the relationships or classes involved in the Type 1 rule. These classes or relationship are defined in the same ontology. In addition, the parameter indicating the type of reasoning rule should be changed from Type 2 to Type 1.

As mentioned earlier, it is possible that a new reasoning rule, particularly Type 1 rule, is stored together with the ontology definition in ontology repository 145. In this case, reasoning rule manager 143 may communicate with ontology repository 145 for storing the new rule, e.g., step 166 and step 167 in FIG. 15. In addition, it is assumed that the same application publishing/managing the ontology makes the reasoning rule here. It is also possible that a different application discovers and understands the ontology first, and then makes a reasoning rule compared with the entity which manages the ontology. In other words, the application making the reasoning rule may be a different application than that creating the ontology. In general, this may be the case for both Type 1 and Type 2 rules.

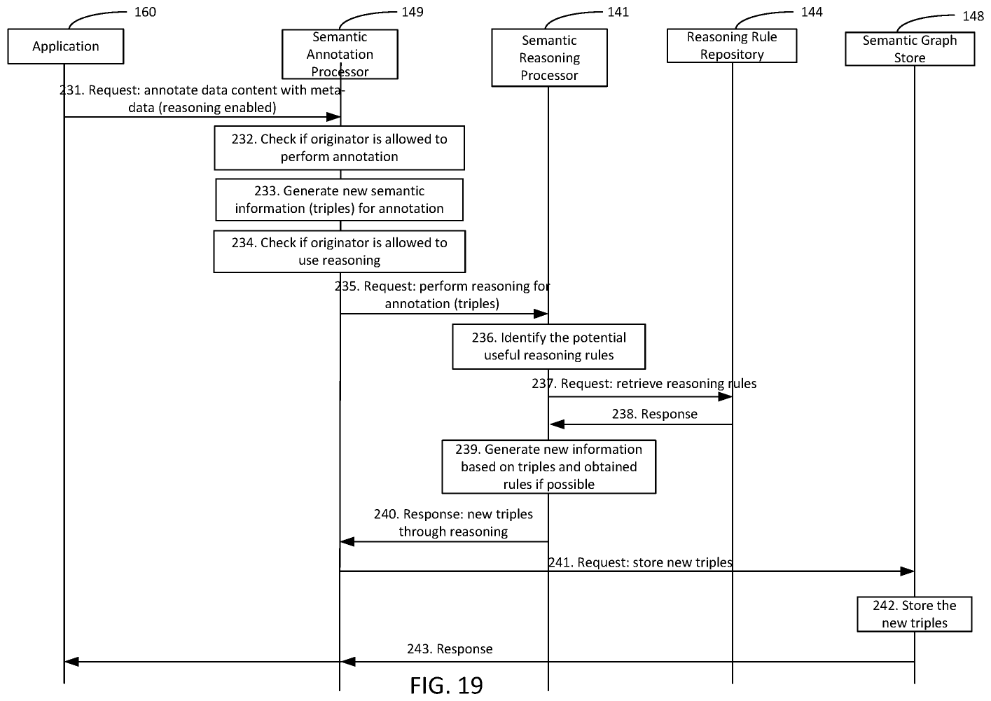

FIG. 16 illustrates an exemplary method of creating a Type 2 reasoning rule when an ontology is updated (e.g., case 2). At step 170, ontology 100 and ontology 101 are stored in the system. This is assumed since the call flow shows the creation of a Type 2 reasoning rule, which connects two ontologies. At step 171 through step 173, application 160 sends the request to update ontology 101, e.g., adding a relationship or class into ontology 101. At step 174 through step 178 of FIG. 16, application 160 follows the same step 165 through step 169 of FIG. 15 to create a new reasoning rule in the rule repository after ontology 101 is successfully updated. FIG. 15 shows the procedure of creating a new rule for case 1, in which a new ontology is published and stored in M2M system, and a new reasoning rule is created between the relationship/class in the new ontology and the relationship/class of an existing ontology in M2M system. FIG. 16 shows the procedure of creating a new rule for case 2, in which a new relationship/class is defined in an existing ontology, and a new reasoning rule is created between this new relationship/class and an existing relationship/class. For case 1, the rule is type 2. The rule could be type 1 or type 2 for case 2. The procedure of creating a new rule may be the same, the trigger is different.

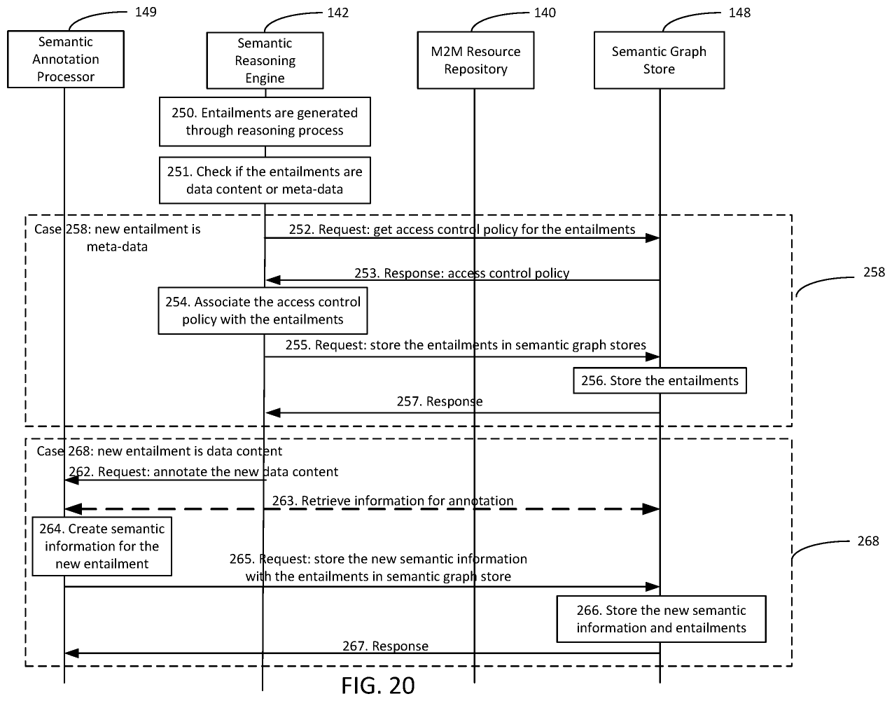

FIG. 17 illustrates an exemplary method for deleting a reasoning rule when an ontology is updated (e.g., a class is deleted or a relationship is updated), which affects the reasoning rule since the reasoning rule defines some logic with the updated class/relationship. When certain relationship or class in an ontology is deleted, or an ontology is removed, it is possible that some reasoning rules need to be deleted. At step 180, both ontology 100 and ontology 101 is created, and a reasoning rule is maintained in reasoning rule repository 144 connecting class/relationship in ontology 100 and ontology 101. At step 181 through step 183, application 160 updates certain class/relationship defined in ontology 101 by contacting ontology repository 145. At step 184, application 160 sends a request to delete the reasoning rules related to the class/relationship in ontology 101 that has been updated. In this case, the request message may contain the link to related class/relationship or wildcard information. Wildcard information may be used to delete a list of rules. For example, if a class A is deleted in step 181, then the application 160 may provide the wildcard information in step 184 asking to delete all reasoning rules involving class A. It is also possible that the reason for step 184 is because application 160 wants to delete a specific reasoning rule. In this case, the reference to identify the target reasoning rule should be provided in the request, e.g., rule ID or URL. It is also possible that the ontology repository sends this request of step 184 to delete the reasoning rules that are affected by the ontology update assuming that ontology repository 145 is capable of detecting the necessity of deleting reasoning rule when an ontology is updated or deleted.

At step 185, reasoning rule manager 143 verifies the request by checking if application 160 has the right to delete a reasoning rule, checking if the target reasoning rule exists, checking if the target reasoning rule is valid, or the like. At step 186 through step 188, reasoning rule manager 143 requests reasoning rule repository 144 to delete the target reasoning rule and response is returned from the reasoning rule repository 144 to reasoning rule manager 143 and application 160. Note that deleting a reasoning rule in step 187 may result in the operations that delete the entailments based on the deleted reasoning rule. To facilitate these operations, the entailments (e.g., new semantic information inferred through reasoning process) are proposed to be stored separately from the original semantic information, and each reasoning rule maintains link(s) to the inferred information that is generated based on the rule. In an example, with regard to being stored separately, the original information may be stored in the TripleStore with a URL: /TripleStore/original_data_1. And then some entailments may be generated based on the original data by applying the reasoning rule, and stored in the TripleStore with a different URL: /TripleStore/entailements_1. Later on, the CRUD operation could be performed on these two separate data sets.

Updating a reasoning rule may trigger some further operations such as updating semantic information generated based on the updated reasoning rule. This kind of operation may incur significant overhead and complexity for synchronization between the reasoning rule and the inferred semantic information. Therefore, directly updating a reasoning rule should be avoided. Instead, it may be done by creating a new reasoning rule while maintaining or deleting the old one if necessary. If the old rule is deleted, the inferred information based on the old rule is also deleted as stated above.

Discussed below are details with regard to triggering of a semantic reasoning process. Semantic reasoning process may be triggered and performed in an on-demand or proactive manner. For example, an application or client may initiate a semantic query request, which may trigger the reasoning process to do some inference and deduction, so that some implicit information may be extracted and returned as a part of semantic query results. Semantic annotation may also proactively trigger the semantic reasoning process when an application is trying to create some semantic information in the semantic graph store. Note the reasoning process may be triggered and performed along with other processes, e.g., semantic query and semantic annotation. Semantic annotation and semantic query processes methods introduced in this section do not contain details about these processes.

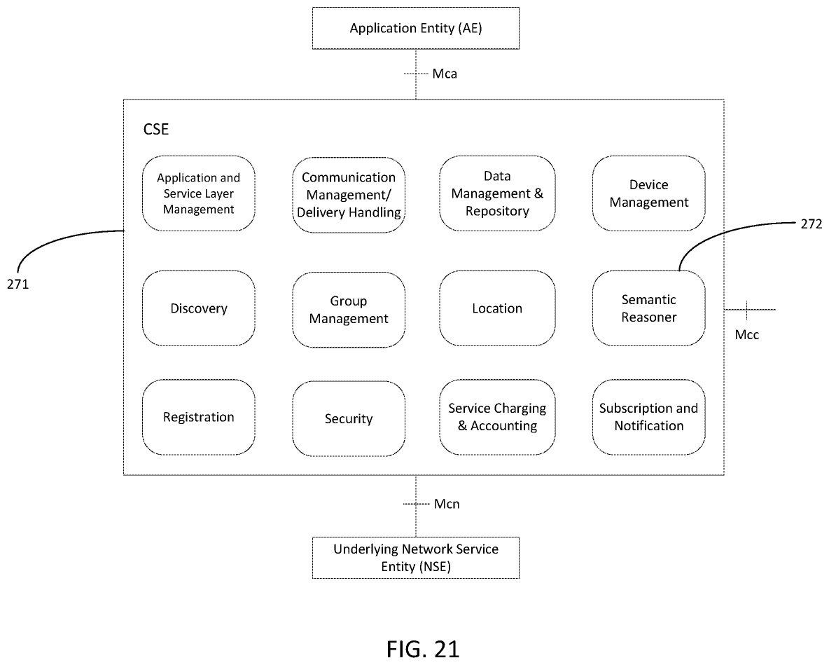

FIG. 18 illustrates an exemplary method of a semantic reasoning process triggered by a semantic query process. At step 211, application 160 initiates a semantic query process by sending a request to semantic query engine 147. In the request of step 211, the parameters related to semantic reasoning may include: reasoning enablement indication, method to process the new information through semantic reasoning, reasoning capability requirement, reference to the reasoning engine, rule return requirement, semantic reasoning rule, or ontology list.

With continued reference to step 211, a reasoning enablement indication may indicate if the application wants to enable (e.g., trigger) the reasoning process during the query. The parameter “Method to process the new information through semantic reasoning” may be an indication of the way to process and deal with new semantic information that is generated via the reasoning process. Potential ways to process may include: 1) store the new metadata permanently in the M2M system or semantic graph store 148; 2) annotate the new content data, if any, by creating some semantic information (e.g., RDF triples); 3) return the new semantic information without storing in the M2M system or semantic graph store 148; or 4) store all the new data in a new separate data set applying the same access control policy used by the original data set.

A reasoning capability requirement may specify what reasoning capability is desired if application 160 enables the reasoning process. Different types of reasoning capabilities may be defined, such as RDFS inference, OWL inference, or general reasoner (e.g., support user defined reasoning rule). A reference to the reasoning engine may indicate which semantic reasoning processor 141 that application 160 desires to use for performing the reasoning process. Different reasoning engines may have different reasoning capabilities, different support format, and different interface (e.g., RESTful). If this is not specified, the default reasoning engine may be used. Note that the reasoning engine may be existing engines (e.g., Pellet, Hermit, Vampire) available through M2M service layer platform or different instances of the same engine. The rule return requirement may indicate if application 160 desires to get notified of which rule is used in the reasoning process. If the rule return requirement is set, the used rule may be returned to application 160 along with query results in step 221. The semantic reasoning rule may allow an application to specify some self-defined rules in a real-time manner. The semantic reasoning rule is besides the reasoning rule that is maintained in the system for reasoning. The ontology list may contain a list of ontologies that are used for discovering the useful reasoning rule. There may be many reasoning rules that involve the same relationship/class, but application 160 may not be interested in all of them. By specifying this list, application 160 may restrict the number of reasoning rules found from reasoning rule repository 144 and minimize significant overhead associated with the reasoning process. For example, a smart home application (e.g., application 160) may want to find an air quality sensor at home, and it may exclude the ontologies defined for agriculture and healthcare domain from the list when discovering a useful reasoning rule, since it won't be interested in the new information generated for those two domains.

With continued reference to FIG. 18, at step 212, upon receiving the query request, semantic query engine 147 checks the reasoning enablement indication. If semantic reasoning is not enabled, semantic query engine 147 just follows the regular query process to process the semantic query request. If the reasoning is enabled (e.g., application 160 desires to perform semantic reasoning along with the query process), semantic query engine 147 may check if application 160 has the rights to use the semantic reasoning as a service. At step 213, if semantic query engine 147 finds out that application 160 is allowed to trigger reasoning along with the semantic query, semantic query engine 147 may send a request to semantic reasoning processor 141. If application 160 does not specify the reference to semantic reasoning processor in the request of step 211, semantic query engine 147 may use the default reasoning processor or initiate a discovery process to find an available reasoning processor.

At step 214, semantic reasoning processor 141 identifies the potentially useful reasoning rule when it receives the request of step 213 for triggering the reasoning process. To identify the useful reasoning rule, a rule manager may look for the rules that relate to the ontology involved in the semantic query process. The semantic query may contain a set of ontology in prefix definition as well as the query body. At step 215, to obtain a useful reasoning rule, semantic reasoning processor 141 may send a request to reasoning rule repository 144 to retrieve the useful rule. The request message may include the semantic query from application 160 in the request, so that the rule manager may return reasoning rules that are related to classes or relationships involved in the query defined in the corresponding ontology. As discussed earlier, in case that the reasoning rule repository 144 co-locates with the ontology repository 145, the request at step 215 goes to the ontology repository 145 to retrieve the potential reasoning rules.

With continued reference to FIG. 18, at step 216, the reasoning rule repository 144 may return reasoning rules that may be helpful in the response, such as the number of rules in the responses, the list of reasoning rules, and reference to other rule repository. The number of rules in the responses may indicate how many rules are identified and returned as a potential useful reasoning rule. The list of reasoning rules may be considered a list of reasoning rules that have been found. The reference to other rule repository may refer to access of another reasoning rule repository 144 in order to find additional reasoning rules, if semantic reasoning processor 141 desires to find more useful reasoning rules or no reasoning rule found in current reasoning rule repository 144. At step 217, once receiving the reasoning rules from reasoning rule repository 144, semantic reasoning processor 141 (e.g., reasoning engine) updates the semantic query by integrating the reasoning rule into the query, so that more information may be returned for the query. For example, light control application 106 of FIG. 7 may initiate a SPARQL query to find the LED lights in the building.

Original SPARQL Query:
Select ?light
Where {
?light rdf:type ontology 101:led_light
}

Given the following reasoning rule presented with reference to the first scenario associated with FIG. 7:

{?light rdf: type ontology101:led_light}=>{?light ontology100:kind “led”}, semantic reasoning processor may update the semantic query as follows:

Updated SPARQL Query:
select ?light
Where {
?light rdf:type ontology 101:led_light
?light rdf:type ontology 100:light
?light ontology 100:kind “led”
}

By doing this with regard to step 217, the query may return some information if the actual semantic information (e.g., RDF triples) is presented based on smart building ontology 100. In other words, this enables interoperability among different domains/verticals (e.g., smart building and light control). It is possible that the devices and appliances in the smart building are described based on ontology 100; while light control application 106 coming from light domain expects the semantic information is expressed based on ontology 101. The reasoning rule then connects the two domains with different terminologies/vocabularies for the same thing. Without such reasoning rule and reasoning capability, light control application 106 may not find a light, since the semantic information is based on ontology 100.

At step 218, semantic reasoning processor 141 returns the updated semantic query to semantic query engine 147. It is also possible that semantic reasoning processor 141 sends the modified semantic query to semantic graph store 148. In this case, step 218 and step 219 is combined from semantic reasoning processor 141 to semantic graph store 148 carrying the updated semantic query request. At steps 219 through 221, semantic query engine 147 contacts semantic graph store 148 to perform the semantic query on the targeted data set (step 220), which returns the results of the query to semantic query engine 147 and application 160.

With continued reference to FIG. 18, alternatively, semantic reasoning processor 141 may exclude the contents of the original query in the updated query (step 217), and may send the request directly to semantic graph store 148 for semantic query and add more triples into the query results when semantic graph store 148 returns the query results.

In addition to semantic query process, semantic reasoning process may also be triggered by semantic annotation process. Semantic annotation of M2M resources is a method for adding semantic information (e.g., metadata, RDF triples) to M2M resources for providing consistent data translation and data interoperability to heterogeneous M2M applications. For example, the temperature may be 20 degrees Fahrenheit in Philadelphia on Friday, Jan. 8, 2016. The value 20 is the data content, which is transparent to applications. Other information (e.g., unit, time, or location) is metadata that describes the data content value 20. Without metadata, the data content itself is opaque to the application from different domains (e.g., smart home and smart transportation), In other words, it may be difficult for application 160 to understand what the content value 20 means. Application 160 may not even know this is a temperature measurement.

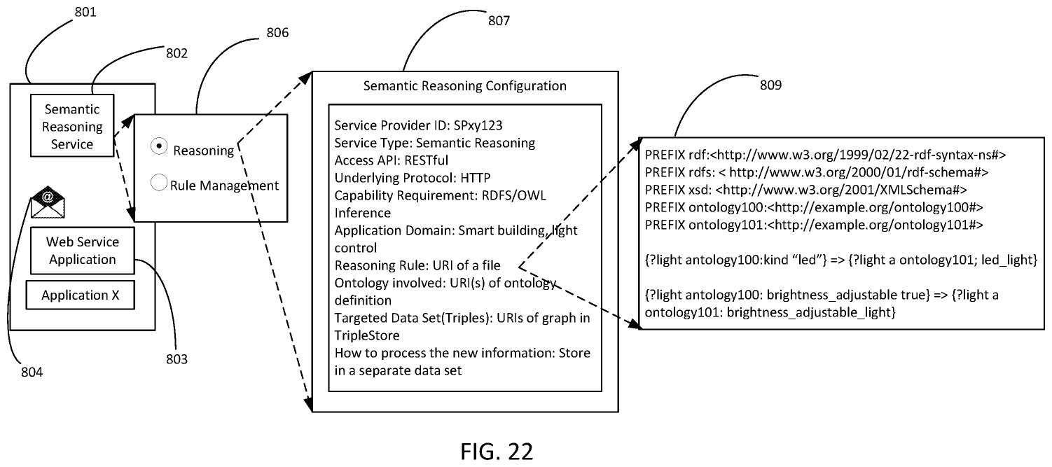

FIG. 19 illustrates an exemplary method of a semantic reasoning process which is triggered by semantic annotation process. At step 231, application 160 sends a semantic annotation request to semantic annotation processor 149 to create some semantic information (e.g., RDF triples) for data content. The request of step 231 may contain similar information as described in step 211 of FIG. 18. Note that the request of step 231 may be integrated with a request when application 160 reports data to the M2M system. For example, when a temperature sensor reports the latest temperature measurement to an M2M server, the sensor may also request semantic annotation processor 149 to create some metadata (e.g., semantic information) to describe the actual temperature value (e.g., temperature measurement). Moreover, reasoning may be enabled in the same message based on the new semantic information. At step 232 through step 233, semantic annotation processor 149 verifies if application 160 is allowed to trigger the annotation, and performs the semantic annotation process by creating semantic information if application 160 has rights to do so. For example at step 233, semantic annotation processor 149 generates new semantic information (triples) for annotation.

At step 234, upon completion of creating semantic information, semantic annotation processor 149 checks if reasoning process is enabled in the request received at step 231, and if application 160 (e.g., the originator) has the right for requesting the reasoning process. At step 235, semantic annotation processer 149 sends a request to semantic reasoning processor 141 to trigger the reasoning process in case application 160 enables the reasoning process in step 231, for example. At step 236 through step 238, semantic reasoning processor 141 follows the similar steps of step 214 through step 216 of FIG. 18 to obtain the useful reasoning rule by contacting the reasoning rule manager (e.g., reasoning rule manager 143) of semantic reasoning processor 141. At step 239, semantic reasoning processor 141 generates some new semantic information which may be based on both the reasoning rule obtained from the reasoning rule manager and the semantic information annotated in step 233. For example, as illustrated in the second scenario that is associated with FIG. 10, a sensor device may be described by the following triple in step 233: :sensorA rdf:type ontology136:multi-functionalAirQualitySensor. Given the reasoning rule obtained in step 236 through step 238: ontology136:multi-functionalAirQualitySensor owl: equivalentClass ontology130:advancedAirQualitySensor. In other words, functionalAirQualitySensor in ontology136 is the same as advancedAirQualitySensor defined in ontology130. An additional triple may be generated by semantic reasoning processor 141 at step 239: :sensorA rdf:type ontology136:advancedAirQualitySensor. This new triple (:sensorA rdf:type ontology130:advancedAirQualitySensor) facilitates the semantic query when some applications attempts to find some air quality sensor to get Carbon monoxide (CO) and Carbon dioxide (CO2) measurement based on ontology 130.

With continued reference to step 240, semantic reasoning processor 141 sends a response to semantic annotation processor 149 with the new semantic information generated through reasoning process. At step 241, semantic annotation processor 149 sends a request to semantic graph store 148 for storing the new semantic information. At step 242, semantic graph store 148 stores the new triples. At step 243, semantic graph store 148 sends a response message, which is associated with step 241, to semantic annotation processor 149 and application 160. In the response message of step 243, semantic graph store 148 may indicate if the semantic information generated through annotation is stored at the same place as semantic information generated through reasoning and provide a reference to the data set where the new semantic information is stored. In addition, the response from semantic annotation processor 149 to application 160 may contain the reference to the original information (e.g., information in step 231 request or triples generated in step 233), if the original information is also stored in the M2M system, e.g., resource tree in oneM2M ROA.

The semantic reasoning process may generate entailments by applying logic represented through the reasoning rule. The entailments are implicit knowledge derived from the semantically annotated data. Depending on the configuration and requirement, the entailments may need to be stored in the semantic graph store, e.g., TripleStore. Presented here are some methods (e.g., configure access control policy or storage) for processing the entailments assuming that the entailments are to be stored in the semantic graph store. Depending on whether the newly generated information is data content or metadata, different steps are performed.

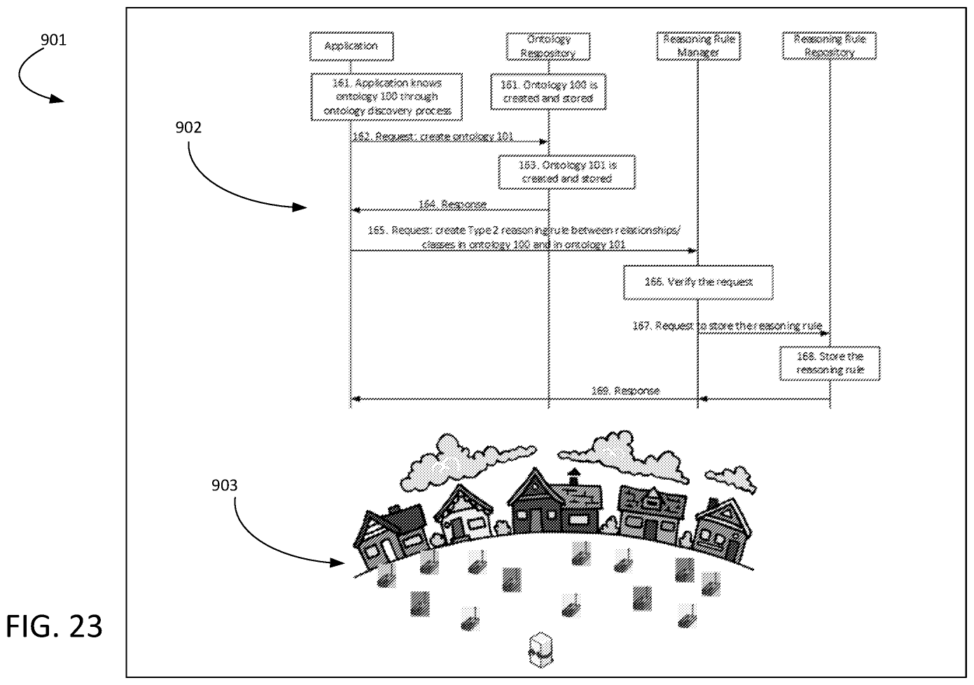

FIG. 20 illustrates an exemplary method of dealing with the entailments. At step 250, the reasoning process is completed (e.g., entailments are already generated). At step 251, semantic reasoning engine 142 checks if the entailment is data content (e.g., mean values of temperature during the past week) or metadata before determining the next steps. In case 258, which include steps 252-step 257, the new entailment is metadata (e.g., semantic information or triples). At step 252, before storing the entailments, access control policy information may be associated with the new entailments. Semantics reasoning engine 142 sends a request to retrieve the access control policy information applied to the original semantic information based on which entailments are generated. For example, which application is allowed to create and delete the original data, which application under a certain set of IP addresses or within an area is allowed to retrieve the original data. This is an example of what access control information. Here it is assumed that the same access control policy is used for the original semantic information and new inferred information (e.g., entailments). Therefore, the request message of step 252 contains the reference to the original semantic information in semantic graph store 148.

At step 253, access control policy applied to the original semantic information is sent to semantics reasoning engine 142. The access control information of step 253 may be in terms of semantic triples or reference to an access control policy resource in the resource tree. At step 254, semantic reasoning engine 142 associates the access control policy with the new entailments (i.e., new semantic information). At step 255, semantic reasoning engine 142 sends a request to semantic graph store 148 to store the new entailments at the desired places (e.g., the same data set as the original semantic information or a new data set). The desired location to store the new entailments may be configured by the entity which triggers the semantic reasoning process or may be the default location if location is not specified. For example, the new semantic information (e.g., RDF triples) may be stored in a separate data set (e.g., /graphStore/entailments1) within the graph store, while the original semantic information is stored in the original data set (e.g., /graphStore/original_data_set_1). In the request, the reasoning engine could use standard format an API to transfer the information, such as SPARQL Update and HTTP interface.

At step 256, entailments may be stored based on the request of step 255. In general, the entailments are stored in the separate data set from the original data. Separate storage may be for easy management or simple access control. With reference to easy management, the entailments may be managed (update or delete) in the future. If they are stored together with the original semantic information, it is difficult to differentiate if semantic information is original or inferred, which may make it more difficult to manage. Correspondingly, each data set is created to store entailments through the reasoning process, and a reference is returned to semantic reasoning engine 142 in step 257.

With regards to simple access control, for the original semantic information, applications from different domains may trigger reasoning process using different rules. These applications may have different access rights, and should not be allowed to access entailments generated for other applications, if it is not authorized. This may support the reason to store entailments separately from the original data.

At step 257, semantic graph store sends response back to the reasoning engine to confirm that the entailments are successfully stored in the desired data set, which could be a new data set or the one containing the original information. Reference to access the data set storing the entailments may be included in the response. Case 268 includes step 262 through step 267.

At step 262, if the entailment is data content (e.g., pure value), which is opaque, then the new data content should be semantically-annotated. For example, based on values of temperature, humidity, or air quality, a comfortable index, which is a number, may be added to describe the numbers, such as when and where the temperature was measured, the unit (e.g., Fahrenheit or Celsius) of the temperature value. To be able to understand the number, it may be beneficial to provide more information, such as date or location. Therefore, semantics reasoning engine 142 may send a request to semantics annotation processor 149 to trigger the semantic annotation process. The request may include the following information: 1) new data content; 2) information to describe new data content; or 3) reference to an ontology, which defines the class and relationship used to annotate the new data content. An example of new data content may be a comfortable index inferred through reasoning process based on the temperature, air quality, and humidity. An example of information to describe the new data content may include location or time of new comfortable index.

With continued reference to FIG. 20, at step 263, semantic annotation processor 149, may contact M2M resource repository 140 and semantic graph store 148 to retrieve more information before annotation, such as access control policy or link to original semantic information. At step 264, semantic annotation processor 149 generates a set of new semantic information (e.g., RDF triples to describe the new data content). At step 265 through step 267, semantic annotation processor 149 communicates with semantic graph store 148 to store the new entailments (e.g., data content) as well as the new semantic information through annotation process. Reference to access the data set is included in the response. More particularly at step 265, a request is sent to store the new semantic information with the entailments in semantic graph store 148. At step 266, semantic graph store 148 stores the new semantic information and entailments. At step 267, semantic graph store 148 sends a response that may include the reference to the data set which stores the new semantic information in the graph store.

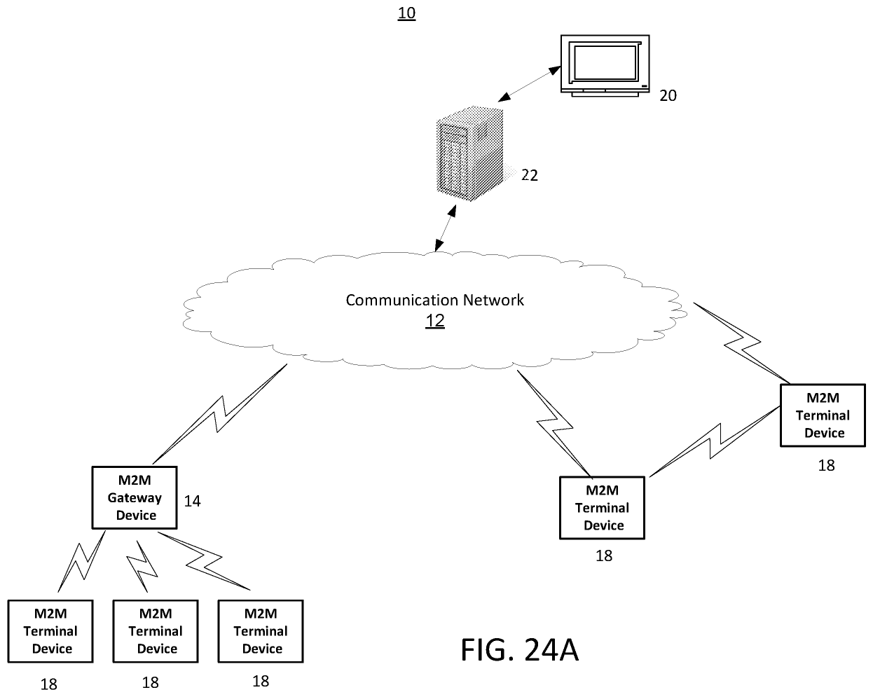

FIG. 21 illustrates an exemplary architecture of semantic reasoner in OneM2M ROA. Disclosed below are some mechanisms that show how to apply the semantic reasoning process in the oneM2M Resource Oriented Architecture (ROA). Semantic reasoner 272 may be deployed as a CSF in a CSE 271. Alternatively, semantic reasoner 272 may be deployed as a part of semantic engine, which is implemented as a CSF in a CSE 271 including several semantic related functionalities such as semantic query, semantic annotation, and semantic reasoning. The proposed CSF could be deployed at end device, M2M gateway or M2M server.

A new resource <reasoningRule> is disclosed for enabling the semantic reasoning capability in the oneM2M ROA. Attributes and child resource are listed in Table 6 (without listing common and universal attributes defined in oneM2M-TS-0001 oneM2M Functional Architecture—V2.5.0).

TABLE 6
Child Resources and Attribute of <reasoningRule> Resource

| New Attributes/ | |
|---|---|
| Child Resources | Description |
| creator | The AE-ID of the entity which created the resource. |
| | This can also be the CSE-ID of the CSE if a CSE |
| | created the resource. |
| ruleID | This attribute uniquely identifies the reasoning rule |
| | represented by this resource. |
| ontologyRef | A reference (URI) of the ontology used to represent |
| | the ontology definition that is used by the reasoning |
| | rule in this resource. If this attribute is not present, |
| | the ontologyRef from the parent resource is used if |
| | present. |
| ruleInOntology | Indicate if there is any reasoning rule defined in the |
| | ontology referred to via the ontologyRef attribute. In |
| | case that an ontology definition is maintained in |
| | oneM2M resource tree through a specific type of |
| | resource, e.g., <ontology>, this attribute is also |
| | applicable to indicate if any reasoning rule is stored |
| | in the ontology definition. This helps discovery of |
| | ontology/reasoning rule and decides if it is beneficial |
| | to trigger semantic reasoning. For example, it is not |
| | easy for an application to determine if there is any |
| | reasoning rule in an ontology definition unless the |
| | application understands the ontology by going |
| | through the definition. This attribute indicates this |
| | information, and thus facilitates the application to |
| | discover the ontology with available reasoning rules. |
| ruleRef | A reference (URI) of the reasoning rule that is stored |
| | outside the oneM2M system in case that same |
| | reasoning rule is exposed to oneM2M by an external |
| | entity. |
| ruleFormat | This attribute indicates the format of the reasoning |
| | rule that is stored in the ruleDescriptor attribute, e.g., |
| | RIF. |
| ruleDescriptor | Stores description of one or more reasoning rules to |
| | represent the reasoning logic. Such a description |
| | shall align with the format specified in the |
| | ruleFormat attribute. |
| ruleStatus | Indicate the status of a reasoning rule, e.g., active or |
| | disabled. |
| links | A list of links pointing to the entailments generated |
| | based on this semantic rule. When this rule is deleted |
| | or updated, these linked entailments will be deleted |
| | or updated accordingly. |
| <reasoningRule> | Contain one or more reasoning rules, i.e., nested |
| | <reasoningRule> resource |
| <subscription> | Contains subscription information for its subscribed- |
| | to resource |

The new resource could be added as a child-resource of <semanticDescriptor> resource, <AE> resource, <container> resource and <contentInstance> resource, <semanticReasoner> resource as introduced later or directly under <CSEBase> resource.

As shown in Table 6, a<reasoningRule> resource may contain one or more <reasoningRule> resources, each of which represents different reasoning rules. This facilitates the implementation of a centralized reasoning rule repository maintaining all the reasoning rules under one <reasoningRule> resource. It is also possible that reasoning rules are stored in a distributed way. Note that the one <reasoningRule> resource may also contain multiple rules in the ruleDescriptor attribute, but these multiple rules should be related to the same set of ontology.

In addition, a<semanticReasoner> resource is proposed to indicate the reasoning capability deployed in the oneM2M system. The attributes and child resource is listed in Table 7.

TABLE 7
Child Resources and Attribute of <semanticReasoner> Resource

| New Attributes/ | |
|---|---|
| Child Resources | Description |
| creator | The AE-ID of the entity which created the |
| | resource. This can also be the CSE-ID of the CSE |
| | if a CSE created the resource. |
| link | Indicate the reference (e.g. URI) to access the |
| | reasoner to trigger the semantic reasoning process |
| reasoningCapability | Indicate the reasoning capability of the reasoner, |
| | e.g., RDFS reasoning, OWL reasoning, user- |
| | defined reasoning rule. |
| name | Indicate the name of the reasoner |
| supportedProtocol | Indicate the type of underlying protocols the |
| | reasoner support. |
| typeOfInterface | Indicate the type of interface supported by the |
| | reasoner, e.g., RESTful, RPC. |
| version | Indicate the version of the reasoner |
| inputFormat | Indicate the input format supported by the |
| | reasoner, e.g., RIF, SWRL. |
| description | Text format description of <semanticReasoner>, |
| | e.g., if it is open source, the license type, the |
| | original contributor. |
| status | Indicate the status of the reasoner, e.g., active, |
| | inactive. |
| <subscription> | Contains subscription information for its |
| | subscribed-to resource |
| <reasoningRule> | Contain one or more reasoning rules |
| <reasoning> | This is a virtual resource to trigger the semantic |
| | reasoning process by using the reasoner identified |
| | through this <semanticReasoner> resource |

As discussed herein, a request message may contain some new parameters for facilitating the reasoning rule management as well as reasoning process.

To enable reasoning rule management, the payload of a request message may include the following information: 1) reasoningRuleType: indicate the type of the reasoning rule to be managed, e.g., create or delete; 2) reasoningRule: description of reasoning rule or reference to access the reasoning rule; 3) storageURI: the location to store a new reasoning rule to be created; or 4) format: the format of expressing the reasoning rule to be managed, e.g., RIF.

To trigger and perform the reasoning process, existing oneM2M request message include enablementIndication, reasoningCapability, or reasoningRuleList, as discussed herein. enablementIndication indicates if reasoning is enabled during the operation requested by the message. For example, when semantic query engine 147 receives a semantic query request, semantic query engine 147 may contact semantic reasoning processor 141 to start reasoning process if this is enabled; otherwise semantic query engine 147 forwards the query to semantic graph store 148. reasoningCapability indicates what reasoning capability is preferred, e.g., RDFS reasoning only or OWL reasoning. This may help to select the reasoner with the desired capability. There may be multiple reasoner available either internally or externally. reasoningRuleList: a list of reasoning rules or reference to a list of reasoning rules to be used in the reasoning process. This allows the application to specify one or more reasoning rules in the request. These rules are defined by the user and provided to reasoning processor in real-time manner, which are different from those already in the system. In other words, this parameter contains some user specific rules, which may not be stored in the system.

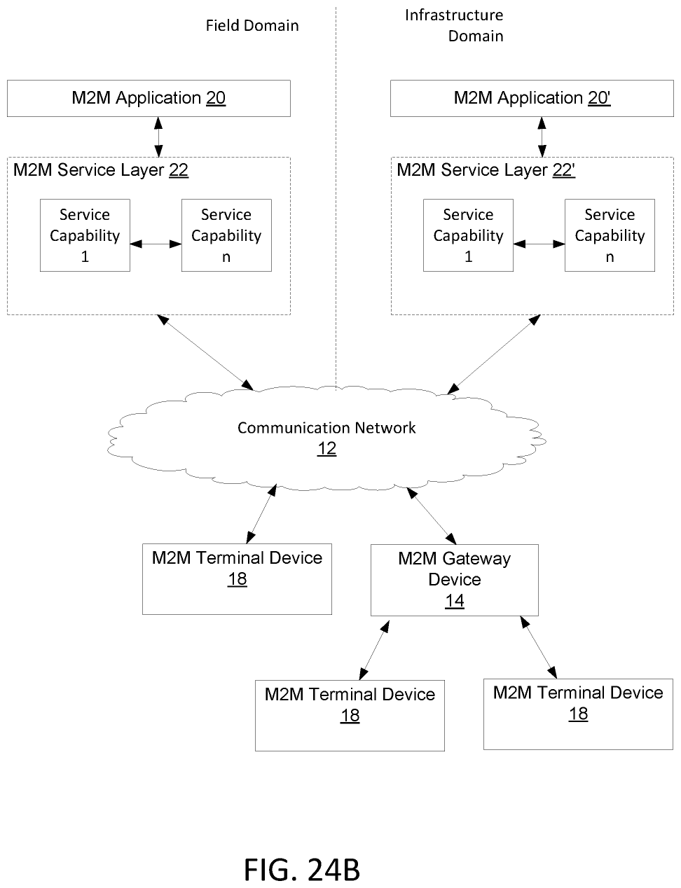

FIG. 22 illustrates an exemplary user interface associated with semantic reasoning as a service. The parameters are defined for enabling and utilizing the semantic reasoning service discussed herein. A user interface may be implemented for configuring or programming those parameters with default values, as well as control switches for enabling or disabling certain features for the semantic reasoning service. Block 801 may be a user interface of a device (e.g., M2M device 30) with different applications, such as semantic reasoning service application 802, web service application 803, or e-mail application 804. Selecting semantic reasoning service application 802 may open a window 806 that provides choices, such as reasoning or rule management. Semantic reasoning configuration associated with enabling a semantic reasoning service, as discussed herein, may be displayed in window 807. Selecting a text in window 807 may open another window 809 that provides additional configuration or parameter information associated with the selection.

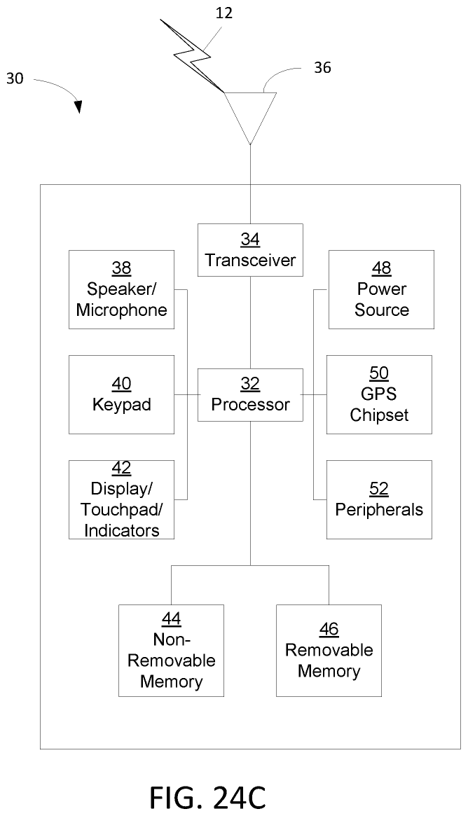

FIG. 23 illustrates another exemplary display (e.g., graphical user interface) that may be generated based on the methods and systems discussed herein. Display interface 901 (e.g., touch screen display) may provide text in block 902 associated with enabling a semantics reasoning service, as discussed herein, such as the parameters of Table 6 and Table 7. In another example, progress of any of the steps (e.g., sent messages or success of steps) discussed herein may be displayed in block 902. In addition, graphical output 903 may be displayed on display interface 901. Graphical output 903 may be the topology of the devices (e.g., sensors), a graphical output of the progress of any method or systems discussed herein, a graphical output of the ontology (e.g., FIG. 8A or FIG. 8B) or the like.

FIG. 24A is a diagram of an example machine-to machine (M2M), Internet of Things (IoT), or Web of Things (WoT) communication system 10 in which one or more disclosed concepts associated with enabling a semantics reasoning service may be implemented (e.g., FIG. 7-FIG. 20 and accompanying discussion). Generally, M2M technologies provide building blocks for the IoT/WoT, and any M2M device, M2M gateway or M2M service platform may be a component of the IoT/WoT as well as an IoT/WoT service layer, etc.

As shown in FIG. 24A, the M2M/IoT/WoT communication system 10 includes a communication network 12. The communication network 12 may be a fixed network (e.g., Ethernet, Fiber, ISDN, PLC, or the like) or a wireless network (e.g., WLAN, cellular, or the like) or a network of heterogeneous networks. For example, the communication network 12 may comprise of multiple access networks that provides content such as voice, data, video, messaging, broadcast, or the like to multiple users. For example, the communication network 12 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network 12 may comprise other networks such as a core network, the Internet, a sensor network, an industrial control network, a personal area network, a fused personal network, a satellite network, a home network, or an enterprise network for example.

As shown in FIG. 24A, the M2M/IoT/WoT communication system 10 may include the Infrastructure Domain and the Field Domain. The Infrastructure Domain refers to the network side of the end-to-end M2M deployment, and the Field Domain refers to the area networks, usually behind an M2M gateway. The Field Domain includes M2M gateways 14 and terminal devices 18. It will be appreciated that any number of M2M gateway devices 14 and M2M terminal devices 18 may be included in the M2M/IoT/WoT communication system 10 as desired. Each of the M2M gateway devices 14 and M2M terminal devices 18 are configured to transmit and receive signals via the communication network 12 or direct radio link. The M2M gateway device 14 allows wireless M2M devices (e.g. cellular and non-cellular) as well as fixed network M2M devices (e.g., PLC) to communicate either through operator networks, such as the communication network 12 or direct radio link. For example, the M2M devices 18 may collect data and send the data, via the communication network 12 or direct radio link, to an M2M application 20 or M2M devices 18. The M2M devices 18 may also receive data from the M2M application 20 or an M2M device 18. Further, data and signals may be sent to and received from the M2M application 20 via an M2M service layer 22, as described below. M2M devices 18 and gateways 14 may communicate via various networks including, cellular, WLAN, WPAN (e.g., Zigbee, 6LoWPAN, Bluetooth), direct radio link, and wireline for example.

Referring to FIG. 24B, the illustrated M2M service layer 22 (e.g., oneM2M CSE of FIG. 7 or FIG. 10 as described herein) in the field domain provides services for the M2M application 20 (e.g., application 160 or light control application 106), M2M gateway devices 14, and M2M terminal devices 18 and the communication network 12. It will be understood that the M2M service layer 22 may communicate with any number of M2M applications, M2M gateway devices 14, M2M terminal devices 18, and communication networks 12 as desired. The M2M service layer 22 may be implemented by one or more servers, computers, or the like. The M2M service layer 22 provides service capabilities that apply to M2M terminal devices 18, M2M gateway devices 14 and M2M applications 20. The functions of the M2M service layer 22 may be implemented in a variety of ways, for example as a web server, in the cellular core network, in the cloud, etc.

Similar to the illustrated M2M service layer 22, there is the M2M service layer 22′ in the Infrastructure Domain. M2M service layer 22′ provides services for the M2M application 20′ and the underlying communication network 12′ in the infrastructure domain. M2M service layer 22′ also provides services for the M2M gateway devices 14 and M2M terminal devices 18 in the field domain. It will be understood that the M2M service layer 22′ may communicate with any number of M2M applications, M2M gateway devices and M2M terminal devices. The M2M service layer 22′ may interact with a service layer by a different service provider. The M2M service layer 22′ may be implemented by one or more servers, computers, virtual machines (e.g., cloud/compute/storage farms, etc.) or the like.

Referring also to FIG. 24B, the M2M service layer 22 and 22′ provide a core set of service delivery capabilities that diverse applications and verticals can leverage. These service capabilities enable M2M applications 20 and 20′ to interact with devices and perform functions such as data collection, data analysis, device management, security, billing, service/device discovery etc. Essentially, these service capabilities free the applications of the burden of implementing these functionalities, thus simplifying application development and reducing cost and time to market. The service layer 22 and 22′ also enables M2M applications 20 and 20′ to communicate through various networks 12 and 12′ in connection with the services that the service layer 22 and 22′ provide.

In some examples, M2M applications 20 and 20′ may include desired applications that communicate using methods or systems enabling a semantics reasoning service, as disclosed herein. The M2M applications 20 and 20′ may include applications in various industries such as, without limitation, transportation, health and wellness, connected home, energy management, asset tracking, and security and surveillance. As mentioned above, the M2M service layer, running across the devices, gateways, and other servers of the system, supports functions such as, for example, data collection, device management, security, billing, location tracking/geofencing, device/service discovery, and legacy systems integration, and provides these functions as services to the M2M applications 20 and 20′.

The methods or systems enabling a semantics reasoning service of the present application may be implemented as part of a service layer. The service layer is a middleware layer that supports value-added service capabilities through a set of application programming interfaces (APIs) and underlying networking interfaces. An M2M entity (e.g., an M2M functional entity such as a device, gateway, or service/platform that is implemented on hardware) may provide an application or service. Both ETSI M2M and oneM2M use a service layer that may contain the methods or systems enabling a semantics reasoning service of the present application. The oneM2M service layer supports a set of Common Service Functions (CSFs) (i.e., service capabilities). An instantiation of a set of one or more particular types of CSFs is referred to as a Common Services Entity (CSE), which can be hosted on different types of network nodes (e.g., infrastructure node, middle node, application-specific node). Further, the methods or systems enabling a semantics reasoning service of the present application can be implemented as part of an M2M network that uses a Service Oriented Architecture (SOA) or a resource-oriented architecture (ROA) to access services such as the methods or systems enabling a semantics reasoning service of the present application.

As disclosed herein, the term “service layer” may be considered a functional layer within a network service architecture. Service layers are typically situated above the application protocol layer such as HTTP, CoAP or MQTT and provide value added services to client applications. The service layer also provides an interface to core networks at a lower resource layer, such as for example, a control layer and transport/access layer. The service layer supports multiple categories of (service) capabilities or functionalities including a service definition, service runtime enablement, policy management, access control, and service clustering. Recently, several industry standards bodies, e.g., oneM2M, have been developing M2M service layers to address the challenges associated with the integration of M2M types of devices and applications into deployments such as the Internet/Web, cellular, enterprise, and home networks. A M2M service layer can provide applications or various devices with access to a collection of or a set of the above mentioned capabilities or functionalities, supported by the service layer, which can be referred to as a CSE or service capability layer (SCL). A few examples include but are not limited to security, charging, data management, device management, discovery, provisioning, and connectivity management which can be commonly used by various applications. These capabilities or functionalities are made available to such various applications via APIs which make use of message formats, resource structures and resource representations defined by the M2M service layer. The CSE or SCL is a functional entity that may be implemented by hardware or software and that provides (service) capabilities or functionalities exposed to various applications or devices (e.g., functional interfaces between such functional entities) in order for them to use such capabilities or functionalities.

FIG. 24C is a system diagram of an example M2M device 30, such as an M2M terminal device 18 (which may include application 160 or light control application 106) or an M2M gateway device 14 (which may include one or more components of FIG. 13), for example. As shown in FIG. 24C, the M2M device 30 may include a processor 32, a transceiver 34, a transmit/receive element 36, a speaker/microphone 38, a keypad 40, a display/touchpad 42, non-removable memory 44, removable memory 46, a power source 48, a global positioning system (GPS) chipset 50, and other peripherals 52. It will be appreciated that the M2M device 30 may include any sub-combination of the foregoing elements while remaining consistent with the disclosed subject matter. M2M device 30 (which may include one or more components of FIG. 7-FIG. 20) may be an exemplary implementation that performs the disclosed systems and methods for enabling a semantics reasoning service.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 32 may perform signal coding, data processing, power control, input/output processing, or any other functionality that enables the M2M device 30 to operate in a wireless environment. The processor 32 may be coupled with the transceiver 34, which may be coupled with the transmit/receive element 36. While FIG. 24C depicts the processor 32 and the transceiver 34 as separate components, it will be appreciated that the processor 32 and the transceiver 34 may be integrated together in an electronic package or chip. The processor 32 may perform application-layer programs (e.g., browsers) or radio access-layer (RAN) programs or communications. The processor 32 may perform security operations such as authentication, security key agreement, or cryptographic operations, such as at the access-layer or application layer for example.

The transmit/receive element 36 may be configured to transmit signals to, or receive signals from, an M2M service platform 22. For example, the transmit/receive element 36 may be an antenna configured to transmit or receive RF signals. The transmit/receive element 36 may support various networks and air interfaces, such as WLAN, WPAN, cellular, and the like. In an example, the transmit/receive element 36 may be an emitter/detector configured to transmit or receive IR, UV, or visible light signals, for example. In yet another example, the transmit/receive element 36 may be configured to transmit and receive both RF and light signals. It will be appreciated that the transmit/receive element 36 may be configured to transmit or receive any combination of wireless or wired signals.

In addition, although the transmit/receive element 36 is depicted in FIG. 24C as a single element, the M2M device 30 may include any number of transmit/receive elements 36. More specifically, the M2M device 30 may employ MIMO technology. Thus, in an example, the M2M device 30 may include two or more transmit/receive elements 36 (e.g., multiple antennas) for transmitting and receiving wireless signals.

The transceiver 34 may be configured to modulate the signals that are to be transmitted by the transmit/receive element 36 and to demodulate the signals that are received by the transmit/receive element 36. As noted above, the M2M device 30 may have multi-mode capabilities. Thus, the transceiver 34 may include multiple transceivers for enabling the M2M device 30 to communicate via multiple RATs, such as UTRA and IEEE 802.11, for example.

The processor 32 may access information from, and store data in, any type of suitable memory, such as the non-removable memory 44 or the removable memory 46. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the M2M device 30, such as on a server or a home computer. The processor 32 may be configured to control lighting patterns, images, or colors on the display or indicators 42 in response to whether the enabling of a semantics reasoning service in some of the examples described herein are successful or unsuccessful (e.g., generally triggering reasoning, semantic query associated reasoning, etc.), or otherwise indicate a status of enabling a semantics reasoning service and associated components. The control lighting patterns, images, or colors on the display or indicators 42 may be reflective of the status of any of the method flows or components in the FIG.'S illustrated or discussed herein (e.g., FIG. 7, FIG. 9, FIG. 14-FIG. 20, etc). Disclosed herein are messages and procedures of enabling a semantics reasoning service. The messages and procedures can be extended to provide interface/API for users to request semantics reasoning service-related resources via an input source (e.g., speaker/microphone 38, keypad 40, or display/touchpad 42) and request, configure, or query semantics reasoning service-related information of resources, among other things that may be displayed on display 42.

The processor 32 may receive power from the power source 48, and may be configured to distribute or control the power to the other components in the M2M device 30. The power source 48 may be any suitable device for powering the M2M device 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled with the GPS chipset 50, which is configured to provide location information (e.g., longitude and latitude) regarding the current location of the M2M device 30. It will be appreciated that the M2M device 30 may acquire location information by way of any suitable location-determination method while remaining consistent with information disclosed herein.

The processor 32 may further be coupled with other peripherals 52, which may include one or more software or hardware modules that provide additional features, functionality or wired or wireless connectivity. For example, the peripherals 52 may include various sensors such as an accelerometer, biometrics (e.g., fingerprint) sensors, an e-compass, a satellite transceiver, a sensor, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The transmit/receive elements 36 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The transmit/receive elements 36 may connect to other components, modules, or systems of such apparatuses or devices via one or more interconnect interfaces, such as an interconnect interface that may comprise one of the peripherals 52.

FIG. 24D is a block diagram of an exemplary computing system 90 on which, for example, the M2M service platform 22 of FIG. 24A and FIG. 24B may be implemented. Computing system 90 (e.g., M2M terminal device 18 or M2M gateway device 14) may comprise a computer or server and may be controlled primarily by computer readable instructions by whatever means such instructions are stored or accessed. Such computer readable instructions may be executed within central processing unit (CPU) 91 to cause computing system 90 to do work. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91, that performs additional functions or assists CPU 91. CPU 91 or coprocessor 81 may receive, generate, and process data related to the disclosed systems and methods for enabling a semantics reasoning service, such as receiving a triggering message, verifying a request, creating a reasoning rule, or the like.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memory devices coupled with system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 can be read or changed by CPU 91 or other hardware devices. Access to RAM 82 or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain network adaptor 97 that may be used to connect computing system 90 to an external communications network, such as network 12 of FIG. 24A and FIG. 24B.

It is understood that any or all of the systems, methods and processes described herein may be embodied in the form of computer executable instructions (i.e., program code) stored on a computer-readable storage medium which instructions, when executed by a machine, such as a computer, server, M2M terminal device, M2M gateway device, or the like, perform or implement the systems, methods and processes described herein. Specifically, any of the steps, operations or functions described above may be implemented in the form of such computer executable instructions. Computer readable storage media include both volatile and nonvolatile, removable and non-removable media implemented in any method or technology for storage of information, but such computer readable storage media do not include signals per se. As evident from the herein description, storage media should be construed to be statutory subject matter. Computer readable storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other physical medium which can be used to store the desired information and which can be accessed by a computer.

In describing preferred methods, systems, or apparatuses of the subject matter of the present disclosure—enabling a semantics reasoning service—as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

The various techniques described herein may be implemented in connection with hardware, firmware, software or, where appropriate, combinations thereof. Such hardware, firmware, and software may reside in apparatuses located at various nodes of a communication network. The apparatuses may operate singly or in combination with each other to effectuate the methods described herein. As used herein, the terms “apparatus,” “network apparatus,” “node,” “device,” “network node,” or the like may be used interchangeably. In addition, the use of the word “or” is generally used inclusively unless otherwise provided herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art (e.g., skipping steps, combining steps, or adding steps between exemplary methods disclosed herein). Such other examples are intended to be within the scope of the claims if they have structural elements that do not differ from the literal language of the claims, or if they include equivalent structural elements with insubstantial differences from the literal languages of the claims.

Methods, systems, and apparatuses, among other things, as described herein may provide for means for enabling a semantics reasoning service. A method, system, computer readable storage medium, or apparatus has means for receiving a request to create a reasoning rule associated with a first ontology and a second ontology; verifying the request to create the reasoning rule associated with the first ontology and the second ontology; based on verifying the request for creating the reasoning rule associated with the first ontology and the second ontology, providing instructions to create the reasoning rule; and receiving a reference to the reasoning rule associated with the first ontology and the second ontology based on the request to create the reasoning rule. The request to create the reasoning rule may include the reasoning rule type. The request to create the reasoning rule may include a reference to the first ontology or the second ontology. The request to create the reasoning rule may include the reasoning rule. The request to create the reasoning rule may include format of the reasoning rule. The request to create the reasoning rule may include a place to store the reasoning rule. The request to create the reasoning rule may include a reference to the first ontology or the second ontology, wherein the reference comprises a uniform resource identifier. The request to create the semantic reasoning rule may be based on detecting a semantic annotation. The method, systems, and apparatuses, among other things, may further provide means for deleting the created semantic reasoning rule based on an update of the first ontology. The method, systems, and apparatuses, among other things, may further provide means for performing a semantic reasoning process disclosed herein triggered by semantic query, semantic annotation, or other triggers. The method, systems, and apparatuses, among other things, may further provide means for managing (e.g., CRUD) new information generated through semantic reasoning process. All combinations in this paragraph (including the removal or addition of steps) are contemplated in a manner that is consistent with the other portions of the detailed description.

1. An apparatus comprising:
a processor; and
a memory coupled with the processor, the memory comprising executable instructions stored thereon that when executed by the processor cause the processor to effectuate operations comprising:
receiving a request to create a semantic reasoning rule associated with a first ontology and a second ontology;
verifying the request to create the semantic reasoning rule associated with the first ontology and the second ontology;
based on verifying the request for creating the semantic reasoning rule associated with the first ontology and the second ontology, providing instructions to create the semantic reasoning rule; and
receiving a reference to the semantic reasoning rule associated with the first ontology and the second ontology based on the request to create the semantic reasoning rule.

2. The apparatus of claim 1, wherein the request to create the semantic reasoning rule comprises the semantic reasoning rule type.

3. The apparatus of claim 1, wherein the request to create the semantic reasoning rule comprises a reference to the first ontology or the second ontology.

4. The apparatus of claim 1, wherein the request to create the semantic reasoning rule is based on detecting a semantic annotation.

5. The apparatus of claim 1, wherein the request to create the semantic reasoning rule comprises format of the semantic reasoning rule.

6. The apparatus of claim 1, wherein the request to create the semantic reasoning rule comprises place to store the semantic reasoning rule.

7. The apparatus of claim 1, wherein the request to create the semantic reasoning rule comprises a reference to the first ontology or the second ontology, wherein the reference comprises a uniform resource identifier.

8. A method comprising:
receiving a request to create a semantic reasoning rule associated with a first ontology and a second ontology;
verifying the request to create the semantic reasoning rule associated with the first ontology and the second ontology;
based on verifying the request for creating the semantic reasoning rule associated with the first ontology and the second ontology, providing instructions to create the semantic reasoning rule; and
receiving a reference to the semantic reasoning rule associated with the first ontology and the second ontology based on the request to create the semantic reasoning rule.

9. The method of claim 8, wherein the request to create the semantic reasoning rule comprises the semantic reasoning rule type.

10. The method of claim 8, wherein the request to create the semantic reasoning rule comprises a reference to the first ontology or the second ontology.

11. The method of claim 8, wherein the request to create the semantic reasoning rule is based on detecting a semantic annotation.

12. The method of claim 8, further comprising deleting the semantic reasoning rule based on an update of the first ontology.

13. The method of claim 8, wherein the request to create the semantic reasoning rule comprises place to store the semantic reasoning rule.

14. The method of claim 8, wherein the request to create the semantic reasoning rule comprises a reference to the first ontology or the second ontology, wherein the reference comprises a uniform resource identifier.

16. A computer readable storage medium storing computer executable instructions that when executed by a computing device cause said computing device to effectuate operations comprising:
receiving a request to create a semantic reasoning rule associated with a first ontology and a second ontology;
verifying the request to create the semantic reasoning rule associated with the first ontology and the second ontology;
based on verifying the request for creating the semantic reasoning rule associated with the first ontology and the second ontology, providing instructions to create the semantic reasoning rule; and
receiving a reference to the semantic reasoning rule associated with the first ontology and the second ontology based on the request to create the semantic reasoning rule.

17. The computer readable storage medium of claim 16, wherein the request to create the semantic reasoning rule comprises the semantic reasoning rule type.

18. The computer readable storage medium of claim 16, wherein the request to create the semantic reasoning rule comprises a reference to the first ontology or the second ontology.

19. The computer readable storage medium of claim 16, wherein the request to create the semantic reasoning rule is based on detecting a semantic annotation.

20. The computer readable storage medium of claim 16, wherein the request to create the semantic reasoning rule comprises place to store the semantic reasoning rule.

21. The computer readable storage medium of claim 16, wherein the request to create the semantic reasoning rule comprises a reference to the first ontology or the second ontology, wherein the reference comprises a uniform resource identifier.
